(19) United States
(12) Patent Application Publication
(10) Pub. No.: US 2015/0301659 A1
(43) Pub. Date: Oct. 22, 2015

(54) TOUCH PANEL MEMBER AND MANUFACTURING METHOD THEREFOR

(71) Applicant: NITTO DENKO CORPORATION, Ibaraki-shi, Osaka (JP)

(72) Inventor: Seiji Umemoto, Ibaraki-shi (JP)

(73) Assignee: NITTO DENKO CORPORATION, Ibaraki-shi, Osaka (JP)

(21) Appl. No.: 14/405,841

(22) PCT Filed: Jun. 6, 2013
(86) PCT No.: PCT/JP2013/065692

§ 371 Date: Dec. 5, 2014

(30) Foreign Application Priority Data
Jun. 7, 2012 (JP) 2012-130032
May 22, 2013 (JP) 2013-108225
May 22, 2013 (JP) 2013-108227
May 22, 2013 (JP) 2013-108231
Jun. 4, 2013 (JP) 2013-117663

(51) Int. Cl. G06F 3/045; G06F 3/044

(52) U.S. Cl. CPC G06F 3/045; G06F 3/044; G06F 2203/04103

(57) ABSTRACT

Provided are a touch panel member, a manufacturing method therefor, and the like that enable the total manufacturing costs and the manufacturing steps to be greatly reduced because a transparent conductive layer can be standardized, and therefore pattern wiring and a control circuit can be standardized and pattern wiring can be easily formed at a low cost. In the present invention, the following are provided: an electrode member (10) in which a transparent electrode layer (12) having a pattern section (12a) that extends horizontally at a constant pitch is formed on the main surface of at least one side of a transparent film substrate (11); and a flexible wiring member (20) having a first connection part (21) disposed at a pitch corresponding to the pitch of the pattern section (12a), and a conductive pattern section (22) that extends from the first connection part.

### TECHNICAL FIELD

The invention relates to a touch panel member including a flexible wiring member and an electrode member that includes a transparent film substrate and a transparent conductive layer formed thereon and is electrically connected to the flexible wiring member. The invention also relates to a touch panel, a method for manufacturing a touch panel member, and a set of material rolls for use in manufacturing a touch panel member. The touch panel member of the invention is suitable for use in a touch panel such as a capacitive touch panel or a resistive touch panel (such as a matrix resistive touch panel), which enables multi-point input.

### BACKGROUND ART

In recent years, there has been a rapidly increasing demand for capacitive touch panels and matrix resistive touch panels because they enables multi-point input (multi-touch) and have good operability. In these touch panels, two transparent conductive films each having transparent conductive layers formed in a stripe pattern on a transparent film substrate are stacked so that the transparent conductive layers form a lattice pattern, or transparent conductive layers in a stripe pattern are formed on both sides of a transparent film substrate in such a manner that the stripe patterns cross each other at right angles. In both cases, a typical structure is such that one end of the stripe pattern is connected to the patterned wiring provided to guide the wiring, and the transparent conductive layer and the patterned wiring are integrally formed on the transparent film substrate.

When such a conventional integrally-formed transparent conductive film is manufactured, the patterned wiring is formed in a different shape for every product on the transparent conductive film. When touch panel-forming sheets are punched out of such a film, parts between regions where the transparent conductive layer and the patterned wiring are formed are wasted as losses, which reduce the area yield of the transparent conductive film. In addition, the patterned wiring needs to be changed for every product, which increases the number of manufacturing steps. In addition, an individual mask shaped for use in etching the transparent conductive layer in a specific pattern needs to be prepared for each product. These problems increase the touch panel manufacturing cost.

Specifically, in a method of forming the patterned wiring by etching a metal thin film formed on the transparent conductive film, the metal thin film must be formed by sputtering or by a process that includes forming an anchor film by sputtering and then increasing the thickness of the film by plating. In both methods, a metal thin film must be formed by sputtering, which is an additional vacuum process. A metal target other than the target for use in forming the transparent conductive film also needs to be prepared, which can cause a significant increase in cost. Part of the formed metal film other than the wiring part to be formed at the periphery of the touch panel must be removed by etching, which can produce a large amount of liquid waste containing ions of the etched metal to cause an environmental loading problem. There is also another problem in that ITO film resistance can increase when the metal thin film is etched.

There is a known technique for forming a transparent conductive film without such integral formation of patterned wiring, which includes providing a long transparent conductive film including a long transparent film substrate and transparent conductive layers formed in a stripe pattern with a constant pitch on the substrate, cutting the transparent conductive film into pieces of a size suitable for a touch panel, and forming a touch panel-forming sheet by stacking the pieces in such a manner that the stripe patterns form a lattice (see, for example, Patent Document 1).

There is also a known method for forming patterned wiring on a touch panel-forming sheet having a stripe pattern, which includes providing a film having a plurality of openings arranged according to a pitch between transparent conductive layers formed in the stripe pattern on the touch panel-forming sheet, laminating the film to the touch panel-forming sheet, then screen-printing conductive ink onto the patterned parts exposed from the openings, respectively, so that patterned wiring is formed (see, for example, Patent Document 2).

### PRIOR ART DOCUMENTS

### Patent Documents

Patent Document 1: JP-W-2008-541430

Patent Document 2: JP-A-06-349372

Patent Document 3: JP-A-2008-129708

### SUMMARY OF THE INVENTION

### Problems to be Solved by the Invention

Unfortunately, the method of forming patterned wiring by screen printing is a complicated process because it requires printing of silver paste or the like according to the pattern of the transparent conductive layers made of ITO or the like and also requires precise alignment. There is also a problem in that printed silver paste needs to be sintered, which requires high-temperature heat treatment, and the resulting patterned wiring has a relatively high resistance.

Conventionally, when the design, shape, wiring pitch, and other features differ for every touch panel product, the touch panel signal differs for every touch panel type. Therefore, IC chips (control circuits) need to be customized for every touch panel product, which causes an increase in touch panel manufacturing cost.

As mentioned above, conventional touch panel members are always individually optimized. As a result of the optimization of individual members, a combination of such members for controlling the characteristics required for each other is not optimal enough for a touch panel. In addition, such touch panel members are not compatible with each other at all. Therefore, their material or design has not been standardized, which causes an increase in total cost.

Long transparent conductive films each having a stripe pattern can be stacked in such a manner that the stripe patterns can form a lattice. In this case, the lattice-patterned part and the non-patterned part (open space part) differ in optical properties (such as refractive index and transmittance), so that the patterned part is more visible, which causes the problem of a reduction in the image quality of a touch panel-type image display device.

On the other hand, a touch panel can be formed by stacking transparent conductive films each having patterned wiring integrally formed and connected to a stripe pattern. It is known that in such a touch panel, a dummy patterned portion is provided between the stripe-patterned portions of at least one of the transparent conductive films (see, for example, Patent Document 3). When such transparent conductive films having patterned wiring formed integrally therewith are used, a dummy pattern can be formed with a high degree of freedom because alignment of two such films to be stacked is determined in advance.

However, when transparent conductive films in which patterned wiring is not integrally formed are used, it will be difficult to keep the transparent conductive films versatile unless the dummy pattern is sophisticatedly formed. In other words, if the pattern is not sophisticatedly formed, a problem can occur in that cut piece size and cutting position will be restricted in the process of cutting the film into pieces suitable for touch panels.

It is therefore an object of the invention to provide a touch panel member that has a transparent conductive layer capable of being standardized so that patterned wiring and control circuit can also be standardized, and also has patterned wiring capable of being formed simply at low cost so that the total manufacturing cost and the manufacturing process can be significantly reduced, and to provide a touch panel and a method for manufacturing a touch panel member.

It is another object of the invention to provide a set of material rolls that can be used in combination to form a touch panel with less visible patterned parts, and allows cut piece size and cutting position to be less restricted when it is cut into pieces suitable for touch panels.

### Means for Solving the Problems

The objects can be achieved by the invention described below.

A touch panel member in accordance with the invention is characterized in that it comprises: an electrode member comprising a transparent film substrate and a transparent conductive layer that is formed on at least one principal surface of the transparent film substrate and has patterned parts arranged with a constant pitch and extending parallel to one another; and a flexible wiring member comprising first connecting parts arranged with a pitch corresponding to the pitch between the patterned parts and conductive patterned parts extending from the first connecting parts, respectively.

According to the touch panel member of the invention, the electrode member including the transparent film substrate and the transparent conductive layer formed thereon is formed independently of the wiring member provided to form patterned wiring, so that the electrode member can be designed independently of patterned wiring to be shaped in various ways. In the electrode member, the transparent conductive layer is formed on at least one principal surface of the transparent film substrate and has patterned parts arranged with a constant pitch and extending parallel to one another. Therefore, the electrode member can be manufactured simply by cutting a piece of a suitable size from a long, wide strip having patterned parts arranged with a constant pitch and extending parallel to one another. Therefore, when the long strip is standardized, the transparent conductive layer can be standardized, so that patterned wiring and control circuits can also be standardized. In addition, the flexible wiring member includes the first connecting parts and the conductive patterned parts extending from the first connecting parts, respectively, in which the first connecting parts are arranged with a pitch corresponding to the pitch between the patterned parts of the electrode member. Therefore, the wiring member and the electrode member can be electrically connected by a simple structure.

In addition, the flexible wiring member having the conductive patterned parts can be simply manufactured at low cost and has no influence on the manufacture of the electrode member, which makes it possible to significantly reduce the total manufacturing cost and manufacturing process. When the touch panel member or members of the invention having these features are used, a pair of the touch panel members may be laminated, or the transparent conductive layers may be provided on both sides of the transparent film substrate, so that the resulting product can be used in the manufacture of a touch panel enabling multi-point input.

In the context of the foregoing, the touch panel member preferably further comprises a conductive connection part adapted to electrically connecting the patterned parts of the electrode member to the first connecting parts. When the conductive connection part with such features is placed between the wiring member and the electrode member, they can be electrically connected by a simple structure.

Also, the touch panel member preferably includes the wiring member and the conductive connection part, wherein the transparent conductive layer is provided on each of both sides of the transparent film substrate, the patterned parts of the two transparent conductive layers on both sides are arranged to cross each other, and the wiring member is provided for each of the two transparent conductive layers. In this structure, the transparent conductive layers are provided on both sides of the transparent film substrate in such a manner that their patterned parts cross each other, which enables detection of multiple input points. Therefore, this structure can form a touch panel member enabling multi-point input.

Alternatively, the touch panel member preferably includes the wiring member and the conductive connection part, wherein two layers of the electrode member are stacked in such a manner that the patterned parts of the two layers are arranged to cross each other without being in contact with each other, and the wiring member is provided for each of the two transparent conductive layers. In this structure, two layers of the electrode member are stacked in such a manner that their patterned parts are arranged to cross each other without being in contact with each other, which enables detection of multiple input points. Therefore, this structure can form a touch panel member enabling multi-point input.

In accordance with the invention, at least one of the two transparent conductive layers preferably has dummy patterned parts that are each provided between the patterned parts and are arranged regularly depending on the pitch between the patterned parts of another of the transparent conductive layers. These dummy patterned parts can be formed in such a manner that the space between the patterned parts of the two transparent conductive layers can be filled with them. Therefore, the dummy patterned parts can reduce the difference in transmittance or the like between the regions with and without the patterned parts, so that the transparent conductive layers can be made further less visible.

Alternatively, it is preferred that the patterned parts of one of the two transparent conductive layers have a plurality of wide portions whose width is made larger depending on the pitch between the patterned parts of another of the two transparent conductive layers, and the patterned parts of said another of the two layers have a plurality of wide portions whose width is made larger depending on the pitch between the patterned parts of said one of the two layers. When the plurality of wide portions are provided, the area of the open space between the patterned parts of the two transparent conductive layer can be reduced, which makes it possible to reduce the difference in transmittance or the like between the regions with and without the patterned parts and to make the transparent conductive layers further less visible.

In the above, the wide portions of the patterned parts of the two transparent conductive layers are preferably diamond-shaped. Therefore, the diamond-shaped wide portions provided in the patterned parts of one layer and the diamond-shaped wide portions provided in the patterned parts of the other layer can reduce, to almost zero, the area of the open space between the patterned parts of the two transparent conductive layers, so that the difference in transmittance or the like between the regions with and without the patterned parts can be further reduced. In addition, the planar distance between the patterned parts of one layer and the patterned parts of the other layer can also be made shorter, so that the sensitivity of position detection can also be increased.

On the other hand, the touch panel of the invention includes the touch panel member having any of the features stated above. The touch panel of the invention can produce the effects described above. Therefore, the transparent conductive layer can be standardized, so that patterned wiring and control circuits can also be standardized and patterned wiring can be formed simply at low cost. The touch panel provided is such that the total manufacturing cost and manufacturing process can be significantly reduced.

On the other hand, the method for manufacturing a touch panel member in accordance with the invention is characterized in that it comprises the steps of:

preparing a material roll comprising a roll of a long strip comprising a transparent film substrate and a transparent conductive layer formed on at least one side of the transparent film substrate, wherein the transparent conductive layer has patterned parts arranged with a constant pitch and extending parallel to one another;

unrolling the long strip from the material roll and thereafter cutting the long strip to form an electrode member comprising a transparent film substrate and a transparent conductive layer formed on at least one principal surface of the transparent film substrate, wherein the transparent conductive layer has patterned parts arranged with a constant pitch and extending parallel to one another;

preparing a flexible wiring member comprising first connecting parts arranged with a pitch corresponding to the pitch between the patterned parts and conductive patterned parts extending from the first connecting parts, respectively; and

electrically connecting the patterned parts of the electrode member to the first connecting parts of the wiring member, respectively, to form a touch panel member.

According to the method of the invention for manufacturing a touch panel member, the electrode member including the transparent film substrate and the transparent conductive layer formed thereon is formed independently of the wiring member provided to form patterned wiring, and then these members are connected, so that the electrode member can be designed independently of patterned wiring to be shaped in various ways. In addition, the electrode member, which includes the transparent film substrate and the transparent conductive layer that is formed on at least one principal surface of the transparent film substrate and has patterned parts arranged with a constant pitch and extending parallel to one another, can be obtained simply by cutting a piece of a suitable size from a long, wide strip having patterned parts arranged with a constant pitch and extending parallel to one another. Therefore, when the long strip is standardized, the transparent conductive layer can be standardized, so that patterned wiring and control circuits can also be standardized. In addition, the flexible wiring member includes the first connecting parts and the conductive patterned parts extending from the first connecting parts, respectively, in which the first connecting parts are arranged with a pitch corresponding to the pitch between the patterned parts of the electrode member. Therefore, the wiring member and the electrode member can be electrically connected by a simple structure.

In addition, the flexible wiring member having the conductive patterned parts can be simply manufactured at low cost and has no influence on the manufacture of the electrode member, which makes it possible to significantly reduce the total manufacturing cost and manufacturing process. When the touch panel member or members obtained according to the invention are used, a pair of the touch panel members may be laminated, or the transparent conductive layers may be provided on both sides of the transparent film substrate, so that the resulting product can be used in the manufacture of a touch panel enabling multi-point input.

In the context of the foregoing, the patterned parts of the material roll preferably extend parallel to the longitudinal or widthwise direction of the long strip. When the patterned parts are arranged in such a direction, rectangular operation areas can be obtained in a higher area yield.

Also, it is preferred that the material roll prepared be a roll of a long strip having the transparent conductive layer formed on each of both sides of the transparent film substrate, wherein the patterned parts of the transparent conductive layers are arranged to cross each other, and the first connecting parts of the wiring member prepared for each of the transparent conductive layers be electrically connected to the patterned parts of the transparent conductive layer, respectively. In the electrode member obtained by this method, the transparent conductive layers are provided on both sides of the transparent film substrate in such a manner that their patterned parts cross each other, which enables detection of multiple input points. Therefore, this method can form a touch panel member enabling multi-point input.

Alternatively, it is preferred that the steps be comprised of preparing two material rolls as said material roll, each comprising a roll of a long strip comprising a transparent film substrate and a transparent conductive layer formed on one side of the transparent film substrate and having patterned parts arranged with a constant pitch and extending parallel to one another, obtaining the electrode member from each of the two material rolls, and laminating the electrode members in such a manner the patterned parts of the electrode members are arranged to cross each other without being in contact with each other, wherein the first connecting parts of the wiring member prepared for each of the transparent conductive layers be electrically connected to the patterned parts of the transparent conductive layer, respectively.

This method can form two layers of the electrode member stacked in such a manner that their patterned parts are arranged to cross each other without being in contact with each other, which enables detection of multiple input points. Therefore, this method can form a touch panel member enabling multi-point input.

It is preferred that at least one of the two transparent conductive layers, formed on both sides of the material rolls, or formed on one side of two material rolls, has dummy patterned parts that are each provided between the patterned parts and are arranged regularly depending on the pitch between the patterned parts of another of the transparent conductive layers. When these dummy patterned parts are formed in the long strip, the electrode member can be formed in such a manner that the space between the patterned parts of the two transparent conductive layers is filled with the dummy patterned parts. Therefore, the dummy patterned parts can reduce the difference in transmittance or the like between the regions with and without the patterned parts, so that the transparent conductive layers can be made further less visible/

Alternatively, it is preferred that the patterned parts, formed on both sides of the material rolls, or formed on one side of two material rolls, wherein the patterned parts of one of the two transparent conductive layers have a plurality of wide portions whose width is made larger depending on the pitch between the patterned parts of another of the two transparent conductive layers, and the patterned parts of said another of the two layers have a plurality of wide portions whose width is made larger depending on the pitch between the patterned parts of said one of the two layers. When the plurality of wide portions are formed in the long strip, the electrode member can be formed in such a manner that the open space area between the patterned parts of the two transparent conductive layers is reduced. Therefore, the wide portions can reduce the difference in transmittance or the like between the regions with and without the patterned parts, so that the transparent conductive layers can be made further less visible.

In the above, the wide portions of the patterned parts of the two transparent conductive layers are preferably diamond-shaped. Therefore, the diamond-shaped wide portions provided in the patterned parts of one layer and the diamond-shaped wide portions provided in the patterned parts of the other layer can reduce, to almost zero, the area of the open space between the patterned parts of the two transparent conductive layers, so that the difference in transmittance or the like between the regions with and without the patterned parts can be further reduced. In addition, the planar distance between the patterned parts of one layer and the patterned parts of the other layer can also be made shorter, so that the sensitivity of position detection can also be increased.

Alternatively, the set of material rolls in accordance with the invention is characterized in that it comprises a set of rolls of long strips each comprising a transparent film substrate and a transparent conductive layer that is formed on one side of the transparent film substrate and has patterned parts arranged with a constant pitch and extending parallel to one another, wherein the transparent conductive layer in at least one of the material rolls has dummy patterned parts that are each provided between each set of the patterned parts and are arranged regularly along the extending direction of the patterned parts depending on the pitch between the patterned parts of the transparent conductive layer in another of the material rolls.

Using the set of material rolls of the invention, an electrode member including a transparent film substrate and a transparent conductive layer formed thereon can be formed independently of a wiring member provided to form patterned wiring, so that a highly versatile electrode member for use in a touch panel can be obtained independently of patterned wiring to be shaped in various ways. At the same time, a combination of electrode members each having patterned parts arranged with a constant pitch and extending parallel to one another can be obtained simply by cutting a piece of a suitable size from each of the long strips unrolled from the material rolls.

In addition, the transparent conductive layer in at least one of the material rolls has a dummy patterned part (s) placed between each set of the patterned parts, which makes the patterned parts in a touch panel less visible. In addition, the dummy patterned parts are arranged regularly along the extending direction of the patterned parts depending on the pitch between the patterned parts of the transparent conductive layer in the other material roll. Therefore, the process of simply cutting an electrode member from one material roll and placing the electrode member on another electrode member, which is obtained from the other material roll, according to the periodic regularity of the latter electrode member makes it possible to place the dummy patterned parts at suitable sites in a lattice of the patterned parts (in other words, as long as the periodic regularity conditions are met, cutting may be performed at any site). Cut piece size is also less restricted because the patterned parts and the dummy patterned parts are each periodically repeated in the structure. Therefore, the cut piece size suitable for the touch panel and the site where the cutting should be performed are less restricted when the set of material rolls is used.

In the context of the foregoing, the dummy patterned parts are each preferably formed to have the same shape and regularity. According to this structure, even if the dummy patterned parts are shifted by one pitch, the resulting dummy patterned parts are the same. Therefore, the cut piece size and the site where the cutting should be performed can be less restricted in this case than in the case where the dummy patterned parts periodically repeat the same shape and regularity.

Alternatively, the patterned parts of the transparent conductive layer in at least one of the material rolls are preferably linearly formed with a constant line width. According to this structure, the linear patterned parts with a constant line width can increase the accuracy of detection of inputs on a projective capacitive touch panel and can form a simpler structure for control circuits and other components when the material rolls or the electrode members are standardized.

In the invention, the patterned parts of the transparent conductive layer in one of the material rolls may extend parallel to the longitudinal direction of the long strip, and the patterned parts of the transparent conductive layer in the other material roll may extend parallel to the widthwise direction of the long strip. In this case, the patterned parts can be arranged in a lattice pattern simply by continuously laminating these long strips into a single sheet, so that the continuous lamination process can further increase the productivity.

Alternatively, the patterned parts of the transparent conductive layers in both of the material rolls may extend parallel to the longitudinal direction of the long strip. In this case, the patterned parts can be continuously formed in a stripe pattern, which can further increase the productivity of the material rolls.

Alternatively, the patterned parts of the transparent conductive layers in both of the material rolls may extend parallel to the widthwise direction of the long strip. In this case, the patterned parts can be continuously formed in a stripe pattern, which can further increase the productivity of the material rolls.

Therefore, a set of material rolls in accordance with the invention is characterized in that it comprises a set of rolls of long strips each comprising a transparent film substrate and a transparent conductive layer that is formed on one side of the transparent film substrate and has patterned parts arranged with a constant pitch and extending parallel to one another, wherein the patterned parts of the transparent conductive layer in one of the material rolls have a plurality of wide portions whose width is made larger depending on the pitch between the patterned parts of the transparent conductive layer in another of the material rolls, and the patterned parts of the transparent conductive layer in said another of the material rolls have a plurality of wide portions whose width is made larger depending on the pitch between the patterned parts of the transparent conductive layer in said one of the material rolls.

Using the set of material rolls of the invention, an electrode member including a transparent film substrate and a transparent conductive layer formed thereon can be formed independently of a wiring member provided to form patterned wiring, so that a highly versatile electrode member for use in a touch panel can be obtained independently of patterned wiring to be shaped in various ways. At the same time, a combination of electrode members each having patterned parts arranged with a constant pitch and extending parallel to one another can be obtained simply by cutting a piece of a suitable size from each of the long strips unrolled from the material rolls.

In addition, the patterned parts of the transparent conductive layer in one of the material rolls have a plurality of wide portions whose width is made larger depending on the pitch between the patterned parts of the transparent conductive layer in the other material roll, and the patterned parts of the transparent conductive layer in the latter material roll have a plurality of wide portions whose width is made larger depending on the pitch between the patterned parts of the transparent conductive layer in the former material roll. Therefore, the wide portions of the patterned parts in both materials can compensate for the non-patterned parts in both materials to make the patterned parts in a touch panel less visible. In addition, using this structure, the process of simply cutting an electrode member from one material roll and placing the electrode member on another electrode member, which is obtained from the other material roll, according to the periodic regularity of the latter electrode member makes it possible to place the patterned parts in such a manner that they can compensate for the non-patterned parts in both members (in other words, as long as the periodic regularity conditions are met, cutting may be performed at any site). Cut piece size is also less restricted because the patterned parts each have a periodically repeated structure. Therefore, the cut piece size suitable for the touch panel and the site where the cutting should be performed are less restricted when the set of material rolls is used.

In the context of the foregoing, the patterned parts of the transparent conductive layer in at least one of the material rolls are preferably each shaped to have a plurality of square portions that have the same size, form the wide portions, respectively, and are joined to one another at their opposite corners.

When the patterned parts are shaped to have a plurality of square portions of the same size joined at their opposite corners, the patterned parts of the transparent conductive layers in both materials can be arranged with substantially the same pitch, so that the horizontal and vertical detection accuracies can be close to each other. In addition, the non-patterned parts can also be shaped to have a plurality of square portions of the same size joined at their opposite corners, so that the non-patterned parts can be easily compensated for by the patterned parts of the transparent conductive layer in the other material.

The patterned parts of the transparent conductive layer in each of both material rolls are preferably each shaped to have a plurality of square portions that form the wide portions, respectively, and are joined to one another at their opposite corners, and the square portions in both material rolls have substantially the same size. Using this configuration, the wide portions of the patterned parts in both materials can compensate for the non-patterned parts in each material, so that the non-patterned parts can be almost completely compensated for, which makes the patterned parts in a touch panel further less visible.

Alternatively, each of the patterned parts of the transparent conductive layer in at least one material roll is preferably shaped to have a plurality of square portions that form the wide portions, have the same size, and are joined at their opposite corners with patterned portions with a constant width. In the case of this configuration, the patterned parts of the transparent conductive layer in the other material can easily compensate for the non-patterned parts. In addition, the opposite corners are joined together with patterned parts with a constant width, which makes the smallest line width portion resistant to disconnection and the like.

Alternatively, each of the patterned parts of the transparent conductive layer in at least one material roll is preferably shaped to have the wide portions that are repeatedly formed between a pair of sine wave-like curves. Also in the case of this configuration, the patterned parts of the transparent conductive layer in the other material can easily compensate for the non-patterned parts.

### BRIEF DESCRIPTION OF THE DRAWINGS

FIGS. 1(a) to 1(c) are views showing an example of the touch panel member of the invention, in which FIG. 1(a) is a plan view, FIG. 1(b) is a partially enlarged view thereof, and FIG. 1(c) is a cross-sectional view thereof;

FIGS. 2(a) to 2(c) are views showing another example of the touch panel member of the invention, in which FIG. 2(a) is a plan view, FIG. 2(b) is a partially enlarged view thereof, and FIG. 2(c) is a cross-sectional view thereof;

FIGS. 3(a) to 3(c) are views showing a further example of the touch panel member of the invention, in which FIG. 3(a) is a plan view, FIG. 3(b) is a partially enlarged view thereof, and FIG. 3(c) is a cross-sectional view thereof;

FIGS. 4(a) to 4(c) are plan views showing examples of the principal part of the touch panel member of the invention;

FIGS. 5(a) and 5(b) are plan views showing a further example of the touch panel member of the invention, in which FIG. 5(a) shows an example where the patterned parts have diamond-shaped wide portions, and FIG. 5(b) shows an example where the patterned parts have sign curve-shaped wide portions;

FIGS. 6(a) to 6(d) are views showing an example of the method of the invention for manufacturing a touch panel member;

FIGS. 7(a) to 7(c) are cross-sectional views showing further examples of the layered structure of the touch panel member of the invention;

FIGS. 8A(a) to 8A(c) are views showing an example of a material roll used in the invention, in which FIG. 8A(a) is a perspective view, FIG. 8A(b) is a partially enlarged plan view thereof, and FIG. 8A(c) is a cross-sectional view showing the layered structure of a long strip;

FIGS. 8B(a) to 8B(c) are views showing an example of a material roll used in the invention, in which FIG. 8B(a) is a perspective view, FIG. 8B(b) is a partially enlarged plan view thereof, and FIG. 8B(c) is a cross-sectional view showing the layered structure of a long strip;

FIGS. 8C(a) to 8C(c) are views showing an example of material rolls used in the invention, in which FIG. 8C(a) is a perspective view, FIG. 8C(b) is a partially enlarged plan view thereof, and FIG. 8C(c) is a cross-sectional view showing the layered structure of a long strip;

FIGS. 8D(a) to 8D(c) are views showing an example of material rolls used in the invention, in which FIG. 8D(a) is a perspective view, FIG. 8D (b) is a partially enlarged plan view thereof, and FIG. 8D(c) is a cross-sectional view showing the layered structure of a long strip;

FIGS. 9A(a) to 9A(c) are plan views showing further examples of the principal part of the material roll used in the invention;

FIGS. 9B(a) and 9B(b) are plan views showing further examples of the principal part of the material roll used in the invention;

FIGS. 10A(a) to 10A(c) are plan views showing further examples of the principal part of the material roll used in the invention;

FIG. 10B is a plan view showing a further example of the principal part of the material roll used in the invention;

FIGS. 11(a) to 11(c) are cross-sectional views showing further examples of the layered structure of a long strip of the material roll used in the invention;

FIGS. 12(a) to 12(c) are views showing an example of the manufactured touch panel member, in which FIG. 12(a) is a plan view, FIG. 12(b) is a partially enlarged view thereof, and FIG. 12(c) is a cross-sectional view thereof;

FIGS. 13A(a) to 13A(c) are views showing another example of the manufactured touch panel member, in which FIG. 13A(a) is a plan view, FIG. 13A(b) is a partially enlarged view thereof, and FIG. 13A(c) is a cross-sectional view thereof;

FIGS. 13B(a) to 13B(c) are views showing a further example of the manufactured touch panel member, in which FIG. 13B(a) is a plan view, FIG. 13B(b) is a partially enlarged view thereof, and FIG. 13B(c) is a cross-sectional view thereof;

FIGS. 13C(a) to 13C(c) are views showing a further example of the manufactured touch panel member, in which FIG. 13C(a) is a plan view, FIG. 13C(b) is a partially enlarged view thereof, and FIG. 13C(c) is a cross-sectional view thereof;

FIGS. 14A(a) to 14A(d) are perspective views showing another example of the method of the invention for manufacturing a touch panel member; and

FIGS. 14B(a) to 14B(d) are perspective views showing a further example of the method of the invention for manufacturing a touch panel member.

### MODE FOR CARRYING OUT THE INVENTION

(Structure of Touch Panel Member)

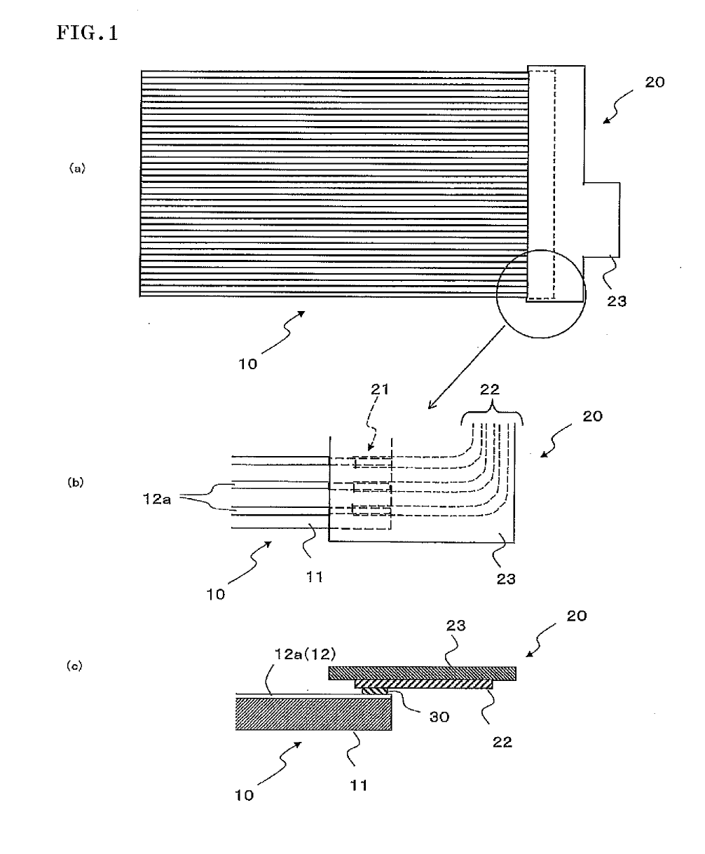

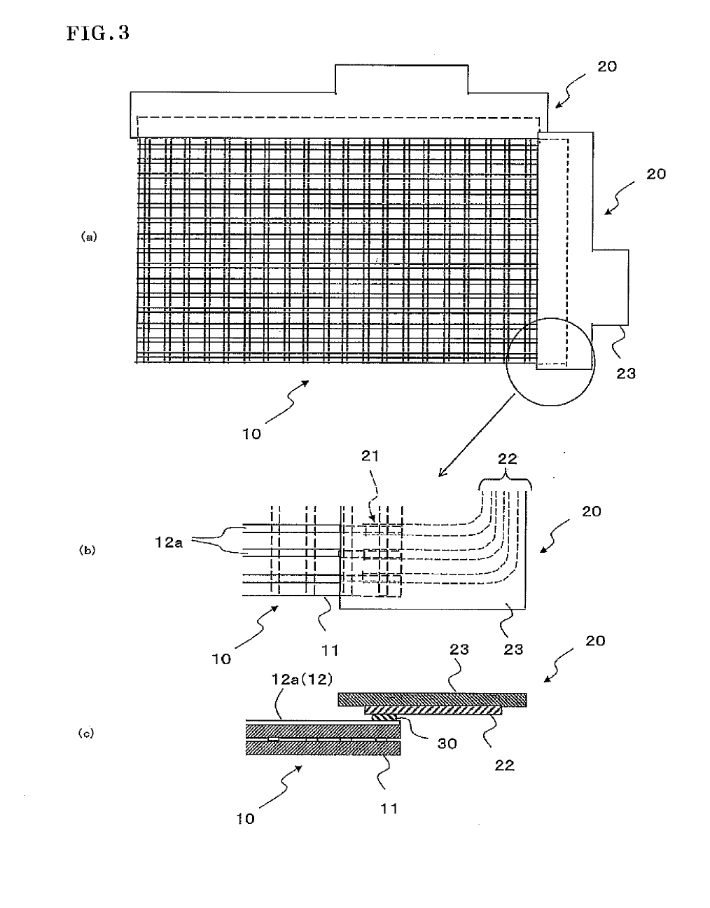

As shown in FIGS. 1(a) to 1(c), the touch panel member of the invention includes an electrode member 10 and a flexible wiring member 20, in which the electrode member 10 includes a transparent film substrate 11 and a transparent conductive layer 12 formed on at least one principal surface of the transparent film substrate 11, and the flexible wiring member 20 has conductive patterned parts 22. FIGS. 1(a) to 1(c) show an example in which the electrode member 10 including the transparent film substrate 11 and the transparent conductive layer 12 formed on one principal surface of the transparent film substrate 11 is paired with the wiring member 20 to form a touch panel member. Two or more touch panel members of this type can be stacked (see FIGS. 3(a) to 3(c)) to form a touch panel member enabling multi-point input. The example of FIGS. 1(a) to 1(c) also has a conductive connection part 30 adapted to electrically connect the electrode member 10 to the wiring member 20.

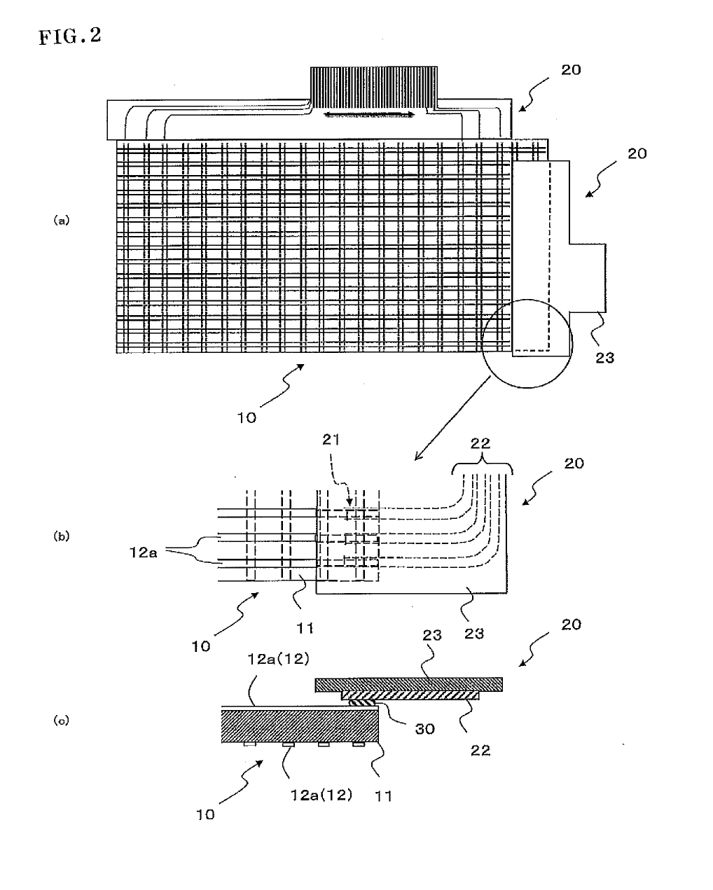

In the electrode member 10, the transparent conductive layer 12 has patterned parts 12a that are arranged with a constant pitch and extend parallel to one another, and the transparent conductive layer 12 is formed on one principal surface (see FIG. 1(c)) of the transparent film substrate 11 or the transparent conductive layers 12 are formed on both principal surfaces (see FIG. 2(c)) of the transparent film substrate 11. As used herein, the phrase “the transparent conductive layer 12 is formed on the principal surface” means that the patterned parts 12a are formed over substantially the entire surface of the transparent film substrate 11 (80% or more, preferably 90% or more, more preferably 95% or more of the entire surface area).

In the example of FIGS. 1(a) to 1(c), the transparent conductive layer 12 has the patterned parts 12a that extend in a direction parallel to the long side of the electrode member 10 and each have a constant width. The electrode member 10 usually has a rectangular or square external shape, but may have any other external shape. Alternatively, the patterned parts 12a extending in parallel may be in a direction oblique to the long side. In view of operation area, however, the patterned parts 12a preferably extend in a direction parallel to the long or short side of the electrode member 10.

The pitch between the patterned parts 12a (the distance between their center lines) is preferably from 1 to 10 mm, more preferably from 2 to 6 mm because the finger size is usually fixed for capacitive touch panels.

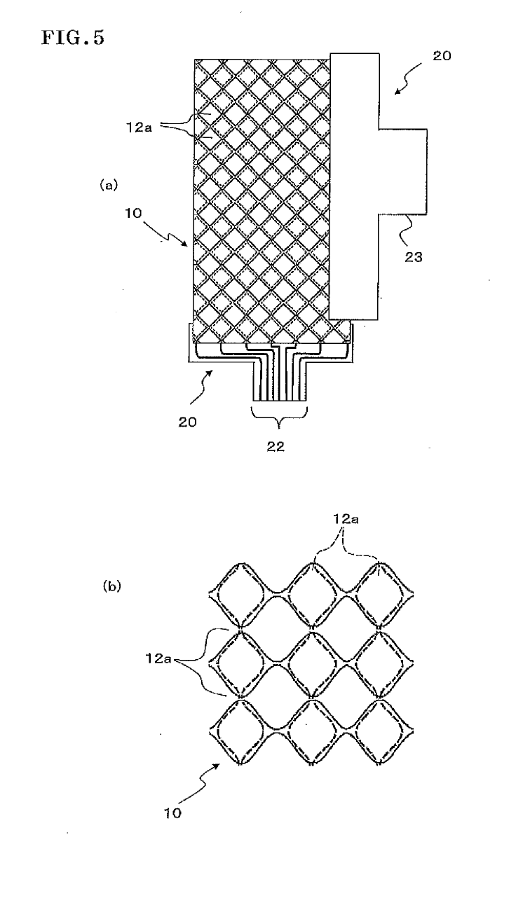

The width of a single pattered part 12a is preferably constant or changed periodically (see FIGS. 5(a) and 5(b)) although it does not have to be constant. When the patterned parts 12a have a constant width, the width is preferably from 1 to 10 mm, more preferably from 2 to 5 mm in view of the accuracy of input detection. When the patterned parts 12a vary in width, their width is preferably close to the pitch because of the sensitivity of detection. If their width is too close to the pitch, however, a short circuit may occur between the adjacent patterned parts depending on processing accuracy. Therefore, the width of the widest portion of the patterned part 12a is preferably 70 to 98%, more preferably 80 to 95% of the pitch between the patterned parts 12a.

In the invention, the pitch between the patterned parts 12a, the line width of the patterned parts 12a, and the material of the patterned parts 12a can be standardized. When the line width is standardized (e.g., 1 mm), the wiring resistance per unit length of the patterned parts 12a formed using ITO or the like can also be standardized. When this type of electrode member 10 is used, the specifications of ICs for control circuits can also be standardized as described below.

The individual patterned parts 12a do not have to be linear and may extend parallel to one another, for example, in a wavy or zigzag form. In the invention, therefore, the individual patterned parts 12a only have to be arranged, without being in contact with one another, in such a manner that the center lines of the wavy or other forms extend parallel to one another.

The transparent film substrate 11 may have any suitable size, which corresponds to the size of an input unit, depending on the size of a display. In the case of a capacitive touch panel, the size of the transparent film substrate 11 is more preferably set suitable for a mobile device in view of the sheet resistance of the transparent conductive film. For example, the size may be 3 to 5 inches for cellular phones or smart phones, 6 to 10 inches for tablet PCs, or 10 to 20 inches for notebook PCs or monitors. In the technique according to the invention, however, relatively small device sizes are preferred in view of connection to the wiring member although such sizes are non-limiting. In the invention where the transparent conductive layer can be standardized, the pitch between the patterned parts 12a, the width of the patterned parts 12a, and the surface resistance of the patterned parts 12a are preferably each set at several different levels depending on the size of parts corresponding to input units.

The flexible wiring member 20 includes first connecting parts 21 and conductive patterned parts 22, in which the first connecting parts 21 are arranged with a pitch corresponding to the pitch between the patterned parts 12a, and the conductive patterned parts 22 are formed to extend from the first connecting parts 21, respectively. The flexible wiring member 20 may be structured similarly to a flexible printed circuit (FPC) board. For example, the flexible wiring member 20 includes a flexible insulating substrate 23 and the conductive patterned parts 22 or the like formed on the flexible insulating substrate 23. In the illustrated example, there is a portion in which the pitch between the conductive patterned parts 22 is made narrower than that between the first connecting parts 21 so that the wiring density is increased.

The wiring member 20 is stacked and disposed on the electrode member 10 so as to be electrically connected to the electrode member 10. The wiring member 20 is stacked and disposed on the electrode member 10 in such a manner that the first connecting parts 21 of the member 20 faces the patterned parts 12a of the electrode member 10, respectively. The wiring member 20 and the electrode member 10 overlap each other preferably over a relatively long distance for good connection between the patterned parts 12a and the first connecting parts 21. In order to narrow the frame, however, the connected part is preferably as short as possible, as long as it can ensure reliability. In general, the overlap distance is preferably, but not limited to, 0.5 to 10 mm, more preferably 1 to 5 mm.

The line width of the first connecting parts 21 is preferably substantially the same as that of the patterned parts 12a or preferably 0.3 to 3 mm in order to provide a good electrical connection to the patterned parts 12a of the transparent conductive layer 12. In view of wiring resistance, the line width is preferably as large as possible.

The opposite ends of the conductive patterned parts 22 from the first connecting parts 21 may also be provided with external connecting parts for connection to an external wiring board. In the invention, therefore, the wiring member 20 can also serve as an FPC for connecting the touch panel to an external wiring board.

In the wiring member 20, the first connecting parts 21 are formed with a pitch that conforms to the standardized stripe pattern of the electrode member 10 so that the first connecting parts 21 can be arranged with a pitch corresponding to the pitch between the patterned parts 12a. Therefore, the wiring member 20 can also be manufactured in several different styles (standardization) depending on the number of the patterned parts 12a of the transparent conductive layer 12.

The conductive connection part 30 is provided to electrically connect the first connecting parts 21 to the patterned parts 12a of the electrode member 10. The conductive connection part 30 may be a solder connection formed using solder or the like, a connection formed using an anisotropic conductive material, a connection formed using a conductive paste, a physical connection, or a fusion bond formed using a low melting point metal. In the invention, the conductive connection part 30 is preferably formed using an anisotropic conductive material.

The anisotropic conductive material may be a polymer film containing conductive particles uniformly dispersed in an adhesive, in which conduction occurs only in the direction of the thickness of the film. The electric connection using the anisotropic conductive material can be made by placing strip-shaped anisotropic conductive materials between the patterned parts 12a of the electrode member 10 and the first connecting parts 21 of the wiring member 20, respectively, and then subjecting them to thermocompression bonding.

The anisotropic conductive material generally has a thickness of about 25 to about 50 μm. The thermocompression bonding may include, for example, pressing under a pressure of 2 to 4 MPa and heating at a temperature of 170 to 220° C., depending on the type of the anisotropic conductive material.

In the invention, as shown in FIGS. 2(a) to 2(c), two transparent conductive layers 12 may be provided on both sides of the transparent film substrate 11 in such a manner that the patterned parts 12a on both sides are arranged to cross each other, and the wiring member 20 and the conductive connection part 30 may be provided for each transparent conductive layer 12.

In the invention, the pattered parts 12a preferably cross each other at an angle of 45 degrees or more, more preferably 85 degrees or more, most preferably 90 degrees. In the illustrated example, the patterned parts 12a cross each other at an angle of 90 degrees.

Each wiring member 20 is stacked and disposed on the electrode member 10 so as to be electrically connected to the electrode member 10. The wiring members 20 are stacked and each disposed on the electrode member 10 in such a manner that the first connecting parts 21 of the wiring members 20 face the patterned parts 12a on both sides of the electrode member 10, respectively. Therefore, one of the wiring members 20 including the first connecting parts 21 and the conductive patterned parts 22 is placed on the lower side, and the other wiring member 20 including the first connecting parts 21 and the conductive patterned parts 22 is placed on the upper side.

The electrode member 10 has overlap portions that are located at one of its long sides and one of its short sides, respectively, and placed over wiring members 20, respectively. When the two overlap portions are provided, each wiring member 20 is electrically connected to an area, the size of which is shorter than the long or short side of the electrode member 10. Therefore, the patterned parts 12a located on the back side of the overlap portion are not used. The patterned parts 12a located at or near one of the four corners of the electrode member 10 are also not used on both sides. Therefore, this portion of the patterned parts 12a may be deleted.

In the invention, as shown in FIGS. 3(a) to 3(c), two layers of the electrode member 10 may form a laminated structure. Specifically, two layers of the electrode member 10 may be stacked in such a manner that the patterned parts 12a are arranged to cross each other without being in contact with each other, and the wiring member 20 and the conductive connection part 30 may be provided for each of the two transparent conductive layers 12. In the illustrated example, the patterned parts 12a are placed on the upper side of each of the two layers of the electrode member 10. The two layers may be laminated with a transparent adhesive, a transparent pressure-sensitive adhesive, or a transparent adhesive film.

Therefore, the two wiring members 20 are arranged in such a manner that the first connecting parts 21 and the conductive patterned parts 22 are both placed on the lower side. The two layers of the electrode member 10 have different shapes, and each have an overlap portion that is placed outside the portion to be used for input and placed over the wiring member 20. The electrode member 10 placed on the lower side has an overlap portion extending toward the upper side of the drawing, and the overlap portion is exposed from the electrode member 10 placed on the upper side. On the other hand, the electrode member 10 on the upper side has an overlap portion extending toward the right side of the drawing, and is so configured that the overlap portion is not placed over the electrode member 10 on the lower side.

Two layers of the electrode member 10 may be stacked in such a manner that the patterned parts 12a of the upper electrode member 10 are placed on the upper side and the pattered parts 12a of the lower electrode member 10 are placed on the lower side. In this case, the resulting structure is similar to that shown in FIGS. 2(a) to 2(c).

Alternatively, the patterned parts 12a of the upper electrode member 10 may be placed on the lower side, and the patterned parts 12a of the lower electrode member 10 may be placed on the upper side. In this case, two layers of the electrode member 10 are preferably bonded with a transparent insulating film or other means interposed therebetween so that the patterned parts 12a can be prevented from being in contact with each other. When the electrode members 10 are stacked in such a manner that the patterned parts 12a of them are opposed to each other, the electrode member 10 placed on the lower side preferably has an overlap portion exposed from the electrode member 10 placed on the upper side, and the electrode member 10 on the upper side preferably has an overlap portion exposed from the electrode member 10 on the lower side.

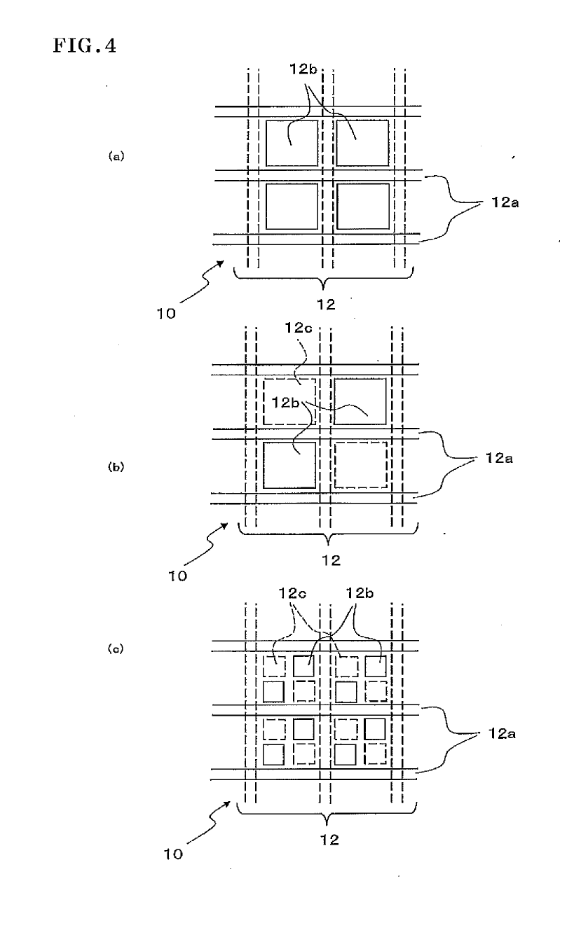

In the invention, as shown in FIGS. 4(a) to 4(c), at least one of the two transparent conductive layers 12 may have dummy patterned parts 12b or 12c, which are placed between the patterned parts 12a and arranged regularly depending on the pitch between the patterned parts 12a of the other layer. As used herein, the term “arranged regularly depending on the pitch” means that the dummy patterned parts 12b or 12c are arranged in a period of about an integral multiple (such as 1-fold, 2-fold, or 3-fold) or about an integral fraction (such as ½ or ⅓) of the pitch.

FIG. 4(a) shows an example in which only one (front-side one) of the two transparent conductive layers 12 has dummy patterned parts 12b on the front side. FIG. 4(b) shows an example in which one of the two transparent layers 12 has dummy patterned parts 12b on the front side, and the other has dummy patterned parts 12c on the back side. FIG. 4(c) shows an example in which the patterned parts 12a in the two layers form a lattice, and a plurality of dummy patterned parts 12b and 12c are provided in a lattice cell.

The examples show that all the dummy patterned parts 12b and 12c are provided in cells of the lattice formed by the patterned parts 12a in the two layers. Alternatively, dummy patterned parts 12b or 12c may be provided so as to cross the patterned parts 12a on the back side. In this case, dummy patterned parts 12b or 12c can be provided having a regularity of about an integral multiple of the pitch.

In the invention, as shown in FIGS. 5(a) to 5(b), the width of the patterned parts 12a of the transparent conductive layers 12 may also be varied. In this case, each patterned part 12a in one of the two transparent conductive layers 12 preferably has a plurality of wide portions whose width is made larger depending on the pitch between the patterned parts 12a in the other layer, and each patterned part 12a in the latter of the two transparent conductive layers 12 preferably has a plurality of wide portions whose width is made larger depending on the pitch between the patterned parts 12a in the former layer. FIG. 5(a) shows an example in which two transparent conductive layers 12 are provided on both sides of the transparent film substrate 11, and the wide portions of each patterned part 12a are diamond-shaped. FIG. 5(b) shows an example in which two transparent conductive layers 12 are provided on both sides of the transparent film substrate 11, and the wide portions of each patterned part 12a have a sine curve shape.

As shown in the above example (see FIGS. 3(a) to 3(c)), such two transparent conductive layers 12 may also be formed by stacking two electrode members 10. The wide portions of each patterned part 12a may be not only diamond-shaped or sine curve-shaped but also a series of other shapes such as circles or polygons.

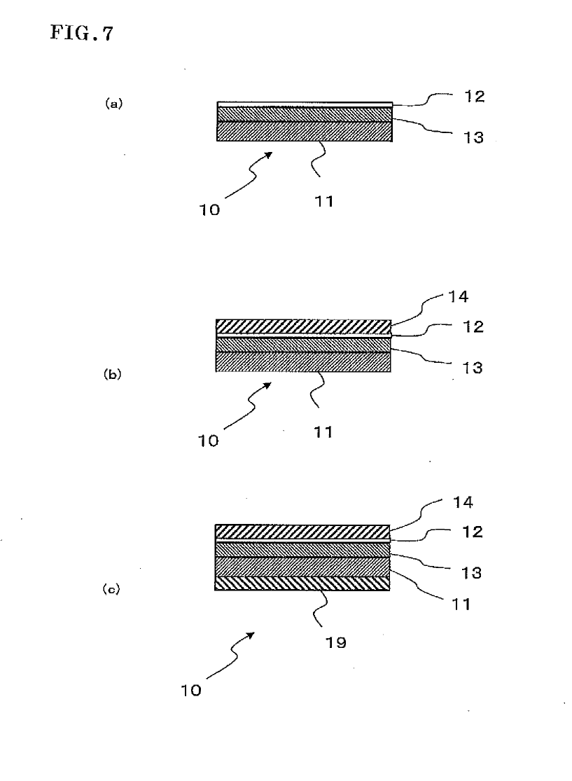

In the examples described above, the transparent conductive layer 12 is formed directly on one or both sides of the transparent film substrate 11. In the invention, however, as shown in FIGS. 7(a) to 7(c), any other layer may also be provided between the transparent conductive layer 12 and the transparent film substrate 11, or any other layer may be provided on the surface of the transparent conductive layer 12 or the transparent film substrate 11.

FIG. 7(a) shows an example in which a dielectric layer 13 is provided between the transparent conductive layer 12 and the transparent film substrate 11. The dielectric layer 13 may be provided to reduce a difference in visibility between the regions of the transparent conductive layer 12 with and without the patterned part 12a. The dielectric layer 13 may have a multilayer structure. Any other layer such as a hard coating layer, a dielectric constant controlling layer, or an anti-reflection (reflection reducing) layer may also be provided between the transparent conductive layer 12 and the transparent film substrate 11.

FIG. 7(b) shows an example in which a hard coating layer 14 is further provided on the surface of the transparent conductive layer 12. The hard coating layer 14 may also be provided with a transparent base material interposed between the layers. The transparent base material may be placed on the layer with a transparent pressure-sensitive adhesive layer or the like.

FIG. 7(c) shows an example in which a transparent pressure-sensitive adhesive layer 19 is further provided on the surface of the transparent film substrate 11. The pressure-sensitive adhesive layer 19 may be used when two electrode members 10 are stacked or when any other member such as a transparent base material or a liquid crystal cell is placed thereon. If necessary, a separator may be placed on the pressure-sensitive adhesive layer 19.

(Materials for Touch Panel Member)

In the invention, the electrode member 10 consists essentially of the transparent conductive layer 12 and the transparent film substrate 11 and, if necessary, may have an optional component such as the dielectric layer 13, the hard coating layer 14, the pressure-sensitive adhesive layer 19, or the transparent base material.

Any of various transparent plastic films may be used as a non-limiting example of the transparent film substrate 11. Examples of materials for the transparent film substrate 11 include polyester resins, acetate resins, polyethersulfone resins, polycarbonate resins, polyamide resins, polyimide resins, polyolefin resins, cycloolefin resins, (meth)acrylic resins, polyvinyl chloride resins, polyvinylidene chloride resins, polystyrene resins, polyvinyl alcohol resins, polyarylate resins, and polyphenylene sulfide resins. In particular, polyester resins, polycarbonate resins, polyolefin resins, and cycloolefin resins are preferred.

A difference in reflectance between the patterned part 12a and the open space should be more effectively reduced. For this purpose, the transparent film substrate 11 preferably has a refractive index of 1.45 or more, more preferably 1.50 to 1.70, even more preferably 1.55 to 1.70. To set the refractive index in these ranges, the transparent film substrate 11 is preferably made of polyester resin such as polyethylene terephthalate or polyethylene naphthalate.

The transparent film substrate 11 preferably has a thickness in the range of 2 to 200 μm, more preferably in the range of 2 to 100 μm. If the transparent film substrate 11 has a thickness of less than 2 μm, the transparent film substrate 11 may have insufficient mechanical strength.

The surface of the transparent film substrate 11 may be previously subjected to sputtering, corona discharge treatment, flame treatment, ultraviolet irradiation, electron beam irradiation, chemical treatment, etching treatment such as oxidation, or undercoating treatment so that it can have improved adhesion to the dielectric layer 13 or other components to be formed on the film substrate.

The dielectric layer 13 may be made of an inorganic material such as NaF (1.3), Na₃AlF₆ (1.35), LiF (1.36), MgF₂ (1.38), CaF₂ (1.4), BaF₂ (1.3), BaF₂ (1.3), SiO₂ (1.46), LaF₃ (1.55), CeF (1.63), or Al₂O₃ (1.63), wherein each number inside the parentheses is the refractive index of each material, an organic material with an refractive index of about 1.4 to about 1.6, such as acrylic resin, urethane resin, melamine resin, alkyd resin, a siloxane polymer, or an organosilane condensate, or a mixture of the inorganic material and the organic material.

Using any of these materials, the dielectric layer 13 can be formed by a dry coating process such as vacuum deposition, sputtering, or ion plating, a wet coating process (coating method), or the like.

The dielectric layer 13 preferably has a thickness of 8 nm or more, more preferably 10 nm or more, even more preferably 15 nm or more.

The transparent conductive layer 12 to be used preferably has a refractive index higher than that of the dielectric layer 13 as mentioned above. The transparent conductive layer 12 usually has a refractive index of about 1.95 to about 2.05.

The material used to form the transparent conductive layer 12 is preferably, but not limited to, a metal oxide of at least one metal selected from the group consisting of indium, tin, zinc, gallium, antimony, titanium, silicon, zirconium, magnesium, aluminum, gold, silver, copper, palladium, and tungsten. If necessary, the metal oxide may further contain any other metal atom selected from the group. For example, tin oxide-doped indium oxide (ITO), antimony-doped tin oxide (ATO), or the like is preferably used.

The transparent conductive layer 12 to be used may also be formed by applying nanowires of a good conductor metal such as silver, gold, copper, or aluminum. The transparent conductive layer 12 may also be formed by fixing particles of any of these good conductor metals using silver halide photography or the like or by a process including applying a solution containing dispersed carbon nanotubes and drying the coating. In the case of silver halide photography, a patterned circuit can also be directly formed by performing exposure to patterned light when particles are formed by reducing silver halide.

The thickness of the transparent conductive layer 12 is preferably, but not limited to, 10 nm or more, so that it can be formed as a highly conductive continuous film with a surface resistance of 1 ×10³ Ω/square or less. If it is too thick, it may cause a reduction in transparency. Therefore, its thickness is preferably in the range of 15 to 35 nm, more preferably in the range of 20 to 30 nm. If the transparent conductive layer has a thickness of less than 10 nm, it may have a higher surface electric resistance and be difficult to form as a continuous film. If the transparent conductive layer has a thickness of more than 35 nm, it may cause a problem such as a reduction in transparency.

The transparent conductive layer 12 may be formed by any conventionally known method. Examples of such a method include vacuum deposition, sputtering, and ion plating. Any appropriate method may also be used depending on the desired thickness. After the transparent conductive layer 12 is formed, if necessary, a heat annealing process may be performed for crystallization thereof.

If the transparent conductive layer 12 is crystallized prior to the patterning of the transparent conductive layer 12 by etching, it can be resistant to the etching. Therefore, the annealing of the transparent conductive layer 12 should preferably be performed after the patterning of the transparent conductive layer 12.

The electrode member 10 may be produced by any method capable of forming the dielectric layer 13 and the transparent conductive layer 12 on one or both sides of the transparent film substrate 11 as described above. According to a conventional method, for example, the electrode member 10 can be produced by a process that includes forming the dielectric layer 13 on one or both sides of the transparent film substrate 11, forming a transparent conductive layer 12-containing transparent conductive film on one or both sides of the transparent film substrate 11 with the dielectric layer 13 interposed therebetween, and optionally patterning the transparent conductive layer 12 by etching. The etching process preferably includes covering the pattern parts 12a with a patterning mask and etching the transparent conductive layer 12 using an etching solution.

The transparent conductive layer 12 is preferably formed using tin oxide-doped indium oxide or antimony-doped tin oxide. Therefore, an acid is preferably used as the etching solution. Examples of the acid include inorganic acids such as hydrochloric acid, hydrobromic acid, sulfuric acid, nitric acid, and phosphoric acid, organic acids such as acetic acid, any mixture thereof, and aqueous solutions thereof.

Two components such as two electrode members 10 may be laminated with a transparent pressure-sensitive adhesive layer 19 interposed therebetween. In this case, the pressure-sensitive adhesive layer 19 may be of any type having transparency. Specifically, for example, a pressure-sensitive adhesive based on a polymer such as an acryl-based polymer, a silicone polymer, polyester, polyurethane, polyamide, polyvinyl ether, a vinyl acetate-vinyl chloride copolymer, modified polyolefin, or a rubber polymer such as an epoxy, fluoride, natural, or synthetic rubber polymer may be appropriately selected and used to form the pressure-sensitive adhesive layer 19. In particular, an acrylic pressure-sensitive adhesive is preferably used because it has a high level of optical transparency, weather resistance, and heat resistance and exhibits a suitable level of adhesive properties such as wettability, cohesiveness, and adhesion.

Some suitable undercoating agents for pressure-sensitive adhesion can be used to increase the anchoring force, depending on the type of the pressure-sensitive adhesive used to form the pressure-sensitive adhesive layer 19. When such a pressure-sensitive adhesive is used, therefore, it is preferred to use an undercoating agent for pressure-sensitive adhesion.

The pressure-sensitive adhesive layer 19 may contain a crosslinking agent depending on the base polymer. If necessary, the pressure-sensitive adhesive layer 19 may also contain any appropriate additive such as a filler including natural or synthetic resin, glass fibers or beads, metal powder, or any other inorganic powder, a pigment, a colorant, or an antioxidant. Transparent fine particles may also be added to impart a light diffusing property to the pressure-sensitive adhesive layer 19.

The pressure-sensitive adhesive layer 19 is usually formed using a pressure-sensitive adhesive solution, which contains a base polymer or a base polymer composition dissolved or dispersed in a solvent and has a solid concentration of about 10 to about 50% by weight. The solvent may be appropriately selected from organic solvents such as toluene and ethyl acetate and water depending on the type of the pressure-sensitive adhesive.

A separator may be attached to the exposed surface of the pressure-sensitive adhesive layer 19. The pressure-sensitive adhesive layer 19 may be transferred using a separator. In this case, for example, such a separator preferably includes a polyester film and a migration-preventing layer and/or a release layer that is placed on the surface of the polyester film to be in contact with at least the pressure-sensitive adhesive layer 19.

The separator preferably has a total thickness of 30 μm or more, more preferably a total thickness in the range of 60 to 100 μm. This is to prevent deformation of the pressure-sensitive adhesive layer 19 (dents) because otherwise when the pressure-sensitive adhesive layer 19 is stored in the form of a roll after formed, such deformation (dents) may be caused by foreign particles or the like caught between parts of the roll.

The migration-preventing layer may be formed using a material suitable for blocking a migrant component in the polyester film, specifically, a low-molecular-weight polyester oligomer component. The release layer may be made of a suitable release agent such as a silicone, long-chain alkyl, or fluoride release agent or molybdenum sulfide.

A hard coating layer (resin layer) 14 may also be formed on the outer surface of the transparent base material. The hard coating layer 14 is preferably a cured coating made from a curable resin such as melamine resin, urethane resin, alkyd resin, acrylic resin, or silicone resin. The hard coating layer 14 preferably has a thickness of 0.1 to 30 μm. If it has a thickness of less than0.1 μm, it may have insufficient hardness. The hard coating layer 14 with a thickness of more than 30 μm may crack or cause the whole of the transparent base material to curl.

To improve visibility, an antiglare layer or an anti-reflection layer may also be formed on the electrode member 10. When the electrode member 10 is used to form a resistive touch panel, the antiglare or anti-reflection layer may be formed on the outer surface of the transparent base material (the surface opposite to the pressure-sensitive adhesive layer 19) similarly to the hard coating layer 14. Alternatively, the antiglare or anti-reflection layer may be formed on the hard coating layer 14. On the other hand, when the electrode member 10 is used to form a capacitive touch panel, the antiglare or anti-reflection layer may be formed on the transparent conductive layer 12 in some cases.

In general, the transparent base material preferably has a thickness of 90 to 300 μm, more preferably 100 to 250 μm. The base material film may be made of the same material as that of the transparent film substrate 11 described above.

The flexible wiring member 20 consists essentially of the flexible insulating substrate 23 and the conductive patterned parts 22 and, if necessary, may have an optional component such as an adhesive layer adapted to bond the insulating substrate 23 and the conductive patterned parts 22, a cover insulating layer adapted to shield the conductive patterned parts 22, or a solder resist layer.

The flexible insulating substrate 23 may be any material having insulating properties and flexibility. For example, a film of resin such as polyimide resin, acrylic resin, polyether nitrile resin, polyether sulfone resin, polyethylene terephthalate resin, polyethylene naphthalate resin, or polyvinyl chloride resin may be used as the flexible insulating substrate 23. Preferably, a polyimide resin film is used. The insulating substrate 23 may also be made of the same material as the transparent film substrate 11, so that the difference in the amount of thermal shrinkage between the two members can be reduced and the reliability of the electrical connection can be further increased.

For example, the insulating substrate 23 preferably has a thickness of 5 to 125 μm, more preferably 12.5 to 25 μm.

Any adhesive may be used to form the adhesive layer. For example, a thermosetting adhesive such as a polyimide adhesive, an epoxy adhesive, an epoxy-nitrile butyl rubber adhesive, an epoxy-acrylic rubber adhesive, an acrylic adhesive, a butyral adhesive, or a urethane adhesive, a thermoplastic adhesive such as a synthetic rubber adhesive, or a pressure-sensitive adhesive such as an acrylic pressure-sensitive adhesive may be used to form the adhesive layer. Preferably, a polyimide adhesive, an epoxy adhesive, an epoxy-nitrile butyl rubber adhesive, an epoxy-acrylic rubber adhesive, or an acrylic adhesive is used to form the adhesive layer. The adhesive layer typically has a thickness of 5 to 35 μm, preferably 5 to 20 μm. The conductive patterned parts and the insulating substrate can be formed by a process including applying a liquid resin layer to a metal foil and curing the resin layer or by a process including forming a metal layer, which is to be used to form the conductive patterned parts, on the insulating substrate by plating or other methods. These processes do not need any adhesive. When plating is used to form the conductive patterned parts, a process including forming a thin metal layer in advance and then forming a metal layer thereon may also be used.

The conductive patterned parts 22 may be made of any material having conductivity. For example, a foil of a metal such as copper, chromium, nickel, aluminum, stainless steel, copper-beryllium, phosphor bronze, iron-nickel, or any alloy thereof maybe used to form the conductive patterned parts 22. A copper foil is preferably used. The conductive patterned parts 22 typically have a thickness of 5 to 35 μm, preferably 5 to 18 μm. However, the thickness may also be less than 5 μm as long as sufficient conductivity is obtained when plating or the like is used to form them.

The conductive patterned parts 22 may be formed using a known process such as a subtractive process. In a subtractive process, first, a photoresist is formed on a conductor layer. For example, a dry film resist may be formed as a photoresist by a known method.

Subsequently, the photoresist is exposed to light through a photomask having a desired pattern, and then the photoresist is developed. The exposure and development of the photoresist may be performed using known methods, in which the photoresist is patterned as desired based on the difference in solubility in developer between the exposed and unexposed parts.

The conductor layer is then etched. The metal foil can be etched by a known wet etching process using an etching solution. The photoresist is then removed by a known method, so that the patterned conductor layer is obtained as the conductive patterned parts 22.

Besides the subtractive process, for example, any other known patterning process such as an additive or semi-additive process may also be used to pattern the conductor layer, depending on purpose and application.

The cover insulating layer may be made of the same resin as listed above, preferably polyimide resin. The cover insulating layer can be formed by a process that includes applying or printing a resin solution and drying and curing the resin solution or bonding a film-shaped resin. Alternatively, a solution of photosensitive resin may be applied and then subjected to patterning into a predetermined shape by exposure and development. The cover insulating layer may also be formed by bonding a film to a predetermined region with an adhesive, in which the film is made of the same material as the insulating substrate. In this case, the insulating substrate and the cover insulating layer do not have to be made of the same material or be the same in thickness. For example, the conductive patterned parts may be formed on a polyethylene terephthalate insulating substrate, and the conductive patterned parts may be covered with a cover insulating layer of a polyethylene terephthalate film.

The cover insulating layer formed in such a way typically has a thickness of 5 to 125 μm, preferably 12.5 to 25 μm.

(Touch Panel)

The touch panel member of the invention is suitable for use in, for example, a capacitive touch panel, a resistive touch panel, or other touch panels. The touch panel member of the invention is particularly suitable for use in a touch panel having a transparent conductive layer patterned in a specific shape, such as a capacitive touch panel or a resistive touch panel designed to enable multi-point input.

When used for a capacitive touch panel, the touch panel member of the invention is electrically connected to a control circuit including IC chips and other components. The control circuit is usually provided on another wiring board. The touch panel member of the invention may be connected directly to the wiring board or connected to the wiring board through another flexible circuit board or the like. In the invention, the wiring member 20 maybe connected directly to the wiring board, or a control circuit may be provided directly on the wiring member 20.

In the invention, the patterned material, the pitch, and the line width in the electrode member 10 can be standardized, which makes it possible to use standardized control circuits and IC chips. This makes it possible for the touch panel manufacturer to easily select a set of chips and to reduce the touch panel cost.

(Method for Manufacturing Touch Panel Member)

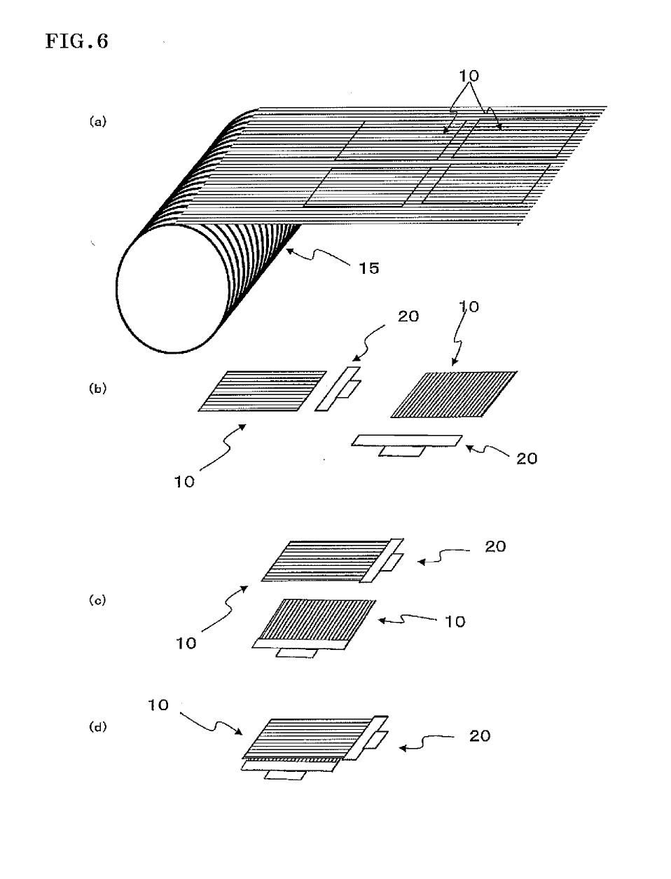

The touch panel member of the invention can be manufactured by a process including the steps shown in FIGS. 6(a) to 6(d). Specifically, the manufacturing process includes the steps of: preparing a material roll 15 including a roll of a long strip including a transparent film substrate and a transparent conductive layer formed on at least one side of the transparent film substrate, wherein the transparent conductive layer has patterned parts arranged with a constant pitch and extending parallel to one another; unrolling the long strip from the material roll 15 and cutting the long strip to form an electrode member 10 including a transparent film substrate 11 and a transparent conductive layer 12 formed on at least one principal surface of the transparent film substrate 11, wherein the transparent conductive layer 12 has patterned parts 12a arranged with a constant pitch and extending parallel to one another; preparing a flexible wiring member 20 including first connecting parts 21 and conductive patterned parts 22 extending from the first connecting parts 21, respectively, wherein the first connecting parts 21 are arranged with a pitch corresponding to the pitch between the patterned parts 12a; and electrically connecting the patterned parts 12a of the electrode member 10 to the first connecting parts 21, respectively, to form a touch panel member.

As shown in FIG. 6(d), the illustrated example of the manufacturing method further includes the step of stacking a plurality of the resulting touch panel members in such a manner that the respective sets of patterned parts 12a are arranged to cross each other without being in contact with each other. This step may be omitted when the material roll 15 used includes a roll of a long strip including a transparent film substrate and transparent conductive layers formed on both sides of the transparent film substrate, wherein the transparent conductive layers each have patterned parts arranged with a constant pitch and extending parallel to one another. The stacking step may also be performed before the patterned parts 12a of the electrode member 10 are electrically connected to the first connecting parts 21.

The cutting step may be performed by a method of punching a piece of a predetermined size out of the strip using a Thomson blade or the like. Alternatively, the cutting step may be performed by a method that includes using the material roll 15 having a width corresponding to the long or short side of the predetermined size and cutting the material into a piece with a length corresponding to the long or short side, in which a cutting blade such as a circular knife, a rotary knife, a knife, or a force-cutting blade, or a laser may be used for the cutting.

In the invention, patterning is not performed for one specific type of touch panel product, but the patterned parts 12a are formed in a certain standard pattern such as a certain standard stripe pattern. In the invention, the material is cut into the electrode members 10 of a predetermined size or sizes, so that touch panel members for touch panel products of various shapes and sizes can be obtained from a material roll having the patterned parts 12a arranged with one or several pitches.

Therefore, the area in which the standard pattern for the electrode member 10 is formed only has to be sufficiently larger than the size of the touch panel member to be formed. For patterning convenience, for example, the area may be formed in each of about 1-m-long separate sections. For example, when the size of the touch panel product is at most about 200 mm×150 mm, the patterns may be formed with a pitch of 1 m in the longitudinal direction, respectively, in the areas with a width of 800 mm. One of the areas can be divided into up to 5 or 6 pieces in the longitudinal direction and 5 or 4 pieces in the widthwise direction, so that 24 or 25 pieces of film can be obtained from one of the areas.

In the invention, the electrode members 10 can be formed by punching pieces, which are shaped depending on the touch panel, out of the long strip in which such a standardized pattern is continuously formed. Therefore, the touch panel members can be obtained from sections that are continuous or almost adjacent to one another, so that they can be produced with almost no loss of film.

Hereinafter, each step will be described in more detail together with other embodiments.

(Step of Preparing Material Roll)

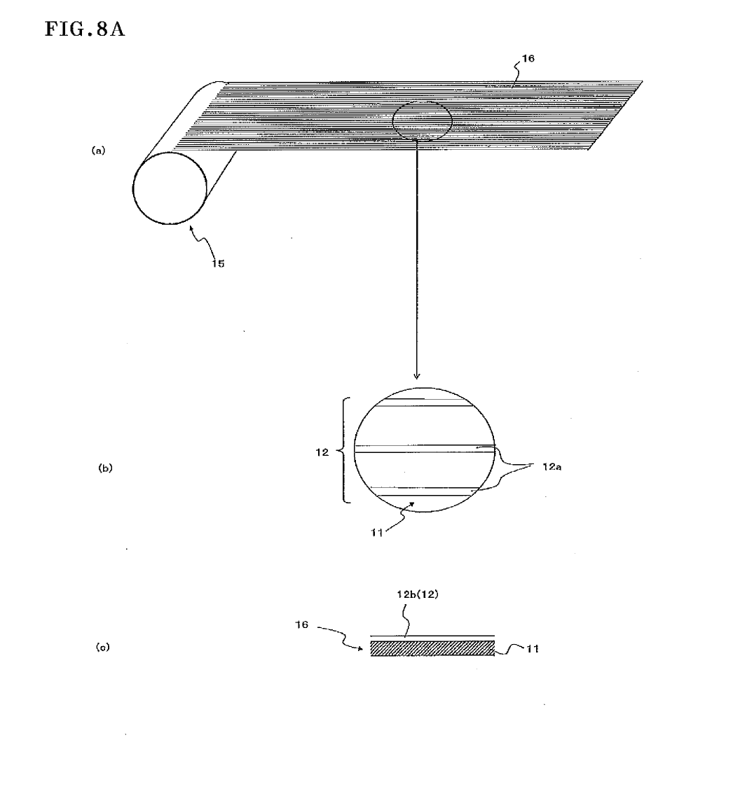

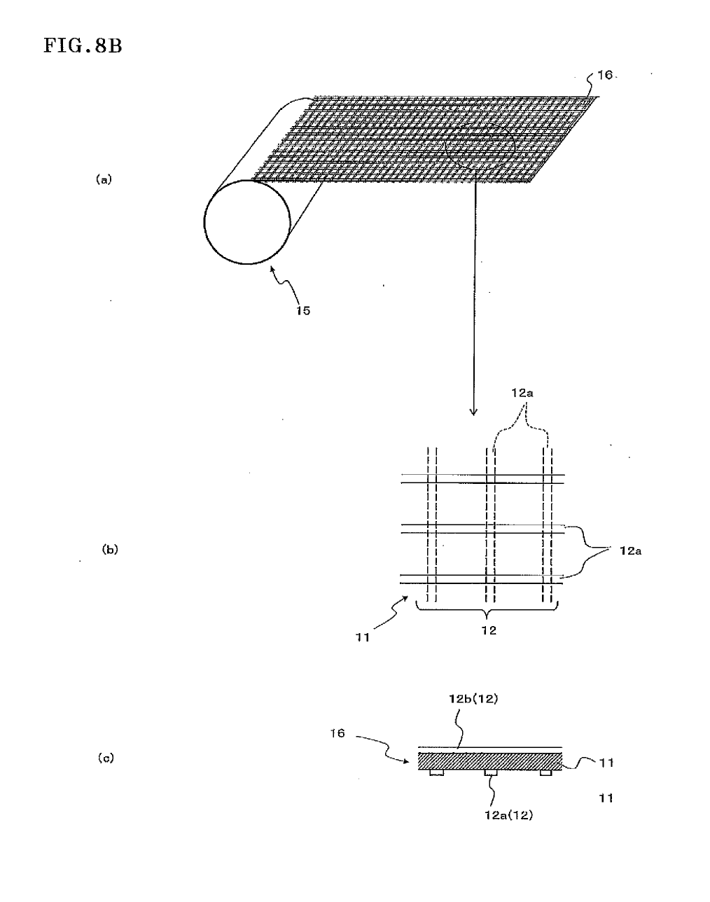

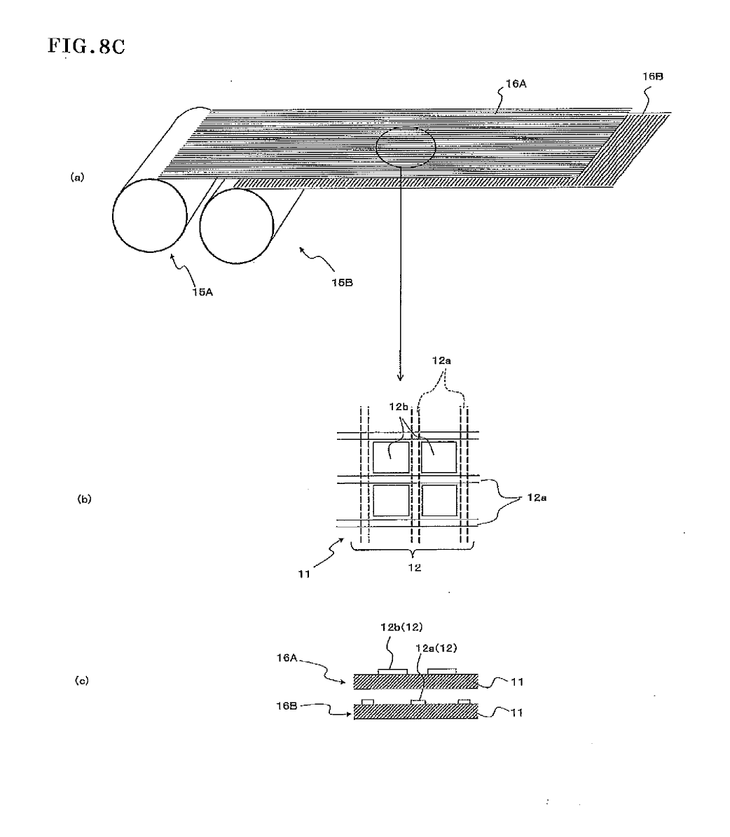

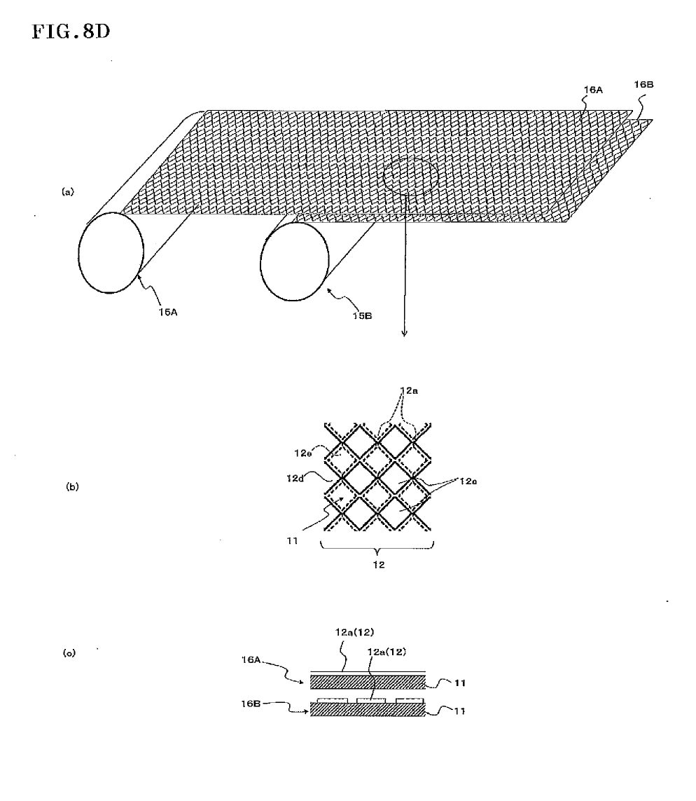

As shown in FIGS. 8A to 8D, the method of the invention for manufacturing a touch panel member includes the step of preparing a material roll 15 including a roll of a long strip 16 including a transparent film substrate 11 and a transparent conductive layer 12 formed on at least one side of the transparent film substrate 11, wherein the transparent conductive layer 12 has patterned parts 12a arranged with a constant pitch and extending parallel to one another. In all the illustrated examples, the transparent conductive layer 12 having patterned parts 12a is formed directly on one side of the transparent film substrate 11.

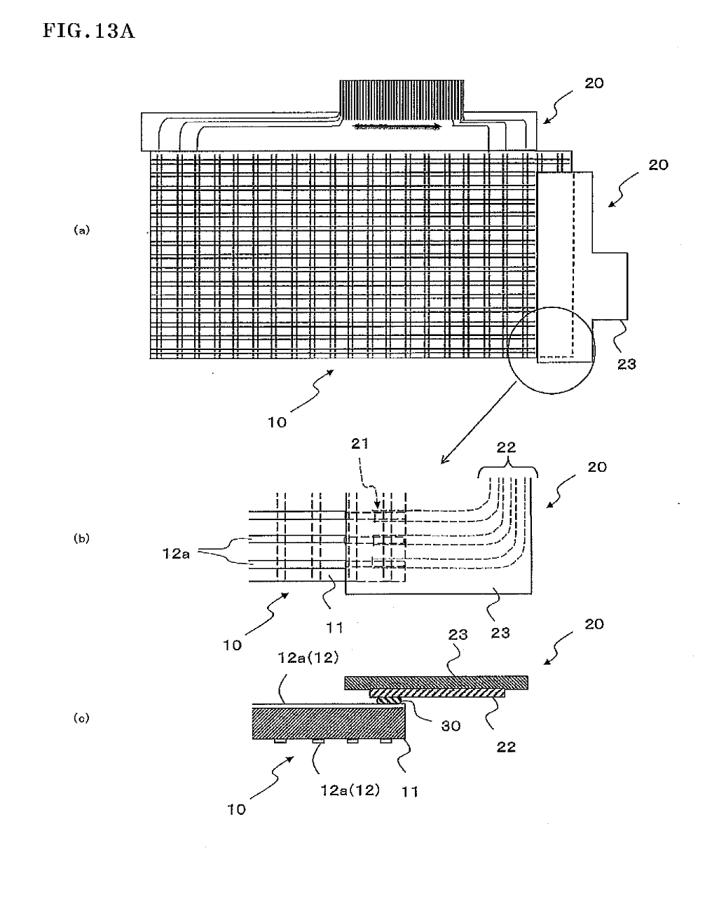

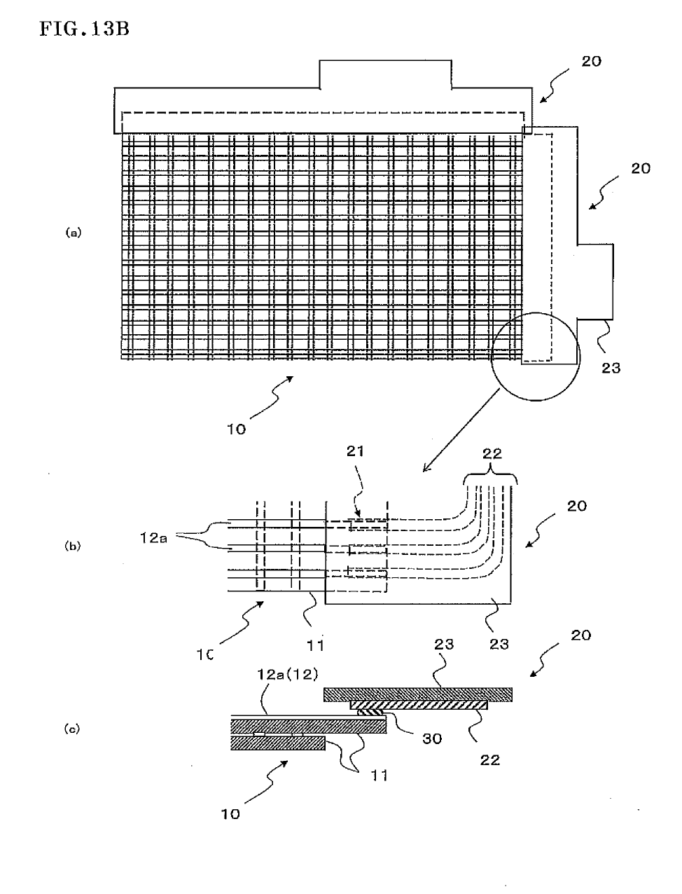

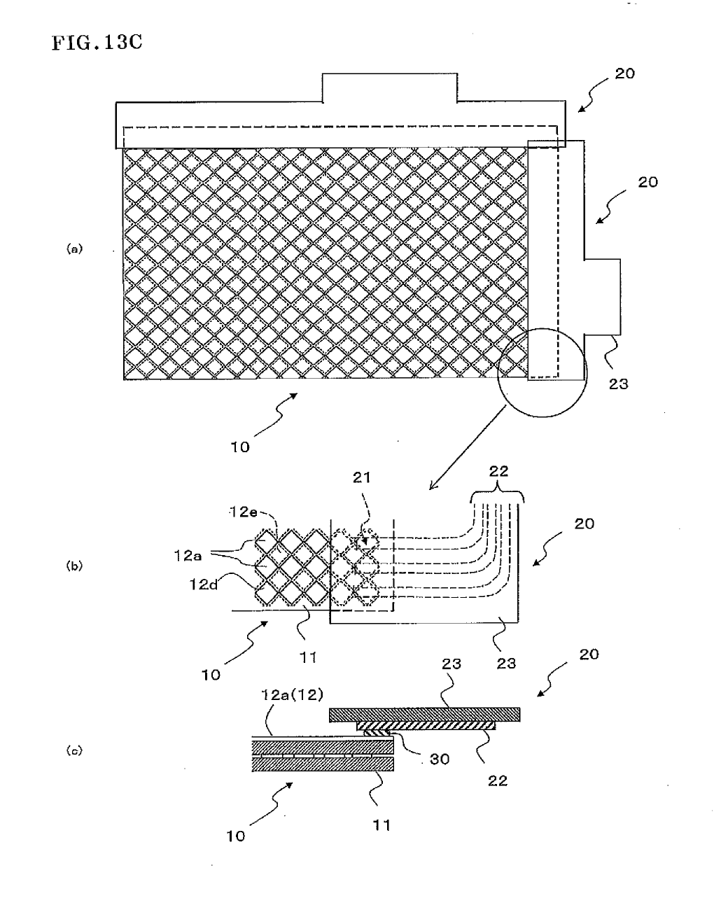

FIG. 8A shows an example in which a touch panel member is manufactured using a single material roll 15 including a transparent film substrate 11 and a transparent conductive layer 12 formed on one side of the transparent film substrate 11. In this example, a touch panel member is formed using a combination of an electrode member 10 and a wiring member 20, in which the electrode member 10 includes a transparent film substrate 11 and a transparent conductive layer 12 formed on one principal surface of the transparent film substrate 11. A plurality of such touch panel members can be stacked (see FIG. 13B) to form a touch panel member that enables multi-point input.

In this illustrated example, the material roll 15 includes a long strip 16A, in which the patterned parts 12a of the transparent conductive layer 12 extend parallel to the longitudinal direction of the long strip 16A. The patterned parts 12a extending in parallel may be inclined to the longitudinal direction of the long strip 16. In view of the process of manufacturing the long strip 16, however, the patterned parts 12a preferably extend in a direction parallel to the longitudinal or widthwise direction of the long strip 16.

The pitch between the patterned parts 12a (or the distance between the center lines of the patterned parts 12a) of the transparent conductive layer 12 is preferably from 1 to 10 mm, more preferably from 2 to 6 mm because the finger size is usually fixed for capacitive touch panels.

The width of a single pattered part 12a is preferably constant or changed periodically (see FIG. 13C) although it does not have to be constant. When the patterned parts 12a have a constant width, the width is preferably from 1 to 10 mm, more preferably from 2 to 5 mm in view of the accuracy of input detection. When the patterned parts 12a vary in width, the width is preferably close to the pitch because of the sensitivity of detection. If the width is too close to the pitch, however, a short circuit may occur between the adjacent patterned parts depending on processing accuracy. Therefore, the width of the widest portion of the patterned part 12a is preferably 70 to 98%, more preferably 80 to 95% of the pitch between the patterned parts 12a.

In the invention, the pitch between the patterned parts 12a, the line width of the patterned parts 12a, and the material of the patterned parts 12a can be standardized. When the line width is standardized (e.g., 1 mm), the wiring resistance per unit length of the patterned parts 12a formed using ITO or the like can also be standardized. When this type of electrode member 10 is used, the specifications of ICs for control circuits can also be standardized as described below.

The individual patterned parts 12a do not have to be linear and may extend parallel to one another, for example, in a wavy or zigzag form. In the invention, therefore, the individual patterned parts 12a only have to be arranged, without being in contact with one another, in such a manner that the center lines of the wavy or other forms extend parallel to one another.

The transparent film substrate 11 may have any suitable size, which corresponds to the size of an input unit, depending on the size of a display. In the case of a capacitive touch panel, the size of the transparent film substrate 11 is more preferably set suitable for a mobile device in view of the sheet resistance of the transparent conductive film. For example, the size may be 3 to 5 inches for cellular phones or smart phones, 6 to 10 inches for tablet PCs, or 10 to 20 inches for notebook PCs or monitors. In the technique according to the invention, however, relatively small device sizes are preferred in view of connection to the wiring member although such sizes are non-limiting. In the invention where the transparent conductive layer can be standardized, the pitch between the patterned parts 12a, the width of the patterned parts 12a, and the surface resistance of the patterned parts 12a are preferably each set at several different levels depending on the size of parts corresponding to input units.

FIG. 8B shows an example in which a touch panel member that enables multi-point input is manufactured using a single material roll 15 including a transparent film substrate 11 and transparent conductive layers 12 formed on both sides of the transparent film substrate 11. In this case, the material roll 15 prepared is a roll of a long strip 16 including the transparent film substrate 11 and the transparent conductive layers 12 formed on both sides of the transparent film substrate 11, in which each transparent conductive layer 12 has patterned parts 12a, and the patterned parts 12a of one of the transparent conductive layers 12 are arranged to cross the patterned parts 12a of the other transparent conductive layer 12. In this example, the patterned parts 12a of each transparent conductive layer 12 are electrically connected to the first connecting parts 21 of each of the wiring members 20 prepared independently (see FIG. 13A).

This example has the same features as the example of FIG. 8A, except that the transparent conductive layers 12 are formed on both sides of the transparent film substrate 11. The patterned parts 12a of the transparent conductive layers 12 may cross each other at an angle other than 90°. However, the patterned parts 12a preferably cross each other at an angle of 85 to 95° so that a higher area yield can be obtained when the operation area is rectangular.

FIG. 8C shows an example in which a touch panel member is manufactured using a set of material rolls 15A and 15B each including a transparent film substrate 11 and a transparent conductive layer 12 formed on one side of the transparent film substrate 11, in which the transparent conductive layer 12 further have dummy patterned parts 12b or 12c.

As shown in FIGS. 8C(a) to 8C(c), a set of material rolls to be used may be a combination of material rolls 15A and 15B, which include a roll of a long strip 16A and a roll of a long strip 16B, respectively. The long strips 16A and 16B each includes a transparent film substrate 11 and a transparent conductive layer 12 that is formed on one side of the transparent film substrate 11 and has patterned parts 12a arranged with a constant pitch and extending parallel to one another. The embodiment provides an example where the transparent conductive layer 12 having patterned parts 12a is formed directly on one side of the transparent film substrate 11.

In the illustrated example, the patterned parts 12a of the transparent conductive layer 12 in one material roll 15A extend parallel to the longitudinal direction of the long strip 16A, and the patterned parts 12a of the transparent conductive layer 12 in the other material roll 15B extend parallel to the widthwise direction of the long strip 16B. The patterned parts 12a extending in parallel may be inclined to the longitudinal direction of the long strips 16A and 16B. In view of the process of manufacturing the long strips 16A and 16B, however, the patterned parts 12a preferably extend in a direction parallel to the longitudinal or widthwise direction of the long strips 16A and 16B. In the invention, therefore, the patterned parts 12a of the transparent conductive layers 12 in both material rolls 15A and 15B may also extend parallel to the widthwise and longitudinal directions of the long strips 16A and 16B, respectively.

The pitch between the patterned parts 12a (or the distance between the center lines of the patterned parts 12a) of the transparent conductive layer 12 is preferably from 1 to 10 mm, more preferably from 2 to 6 mm because the finger size is usually fixed for capacitive touch panels.

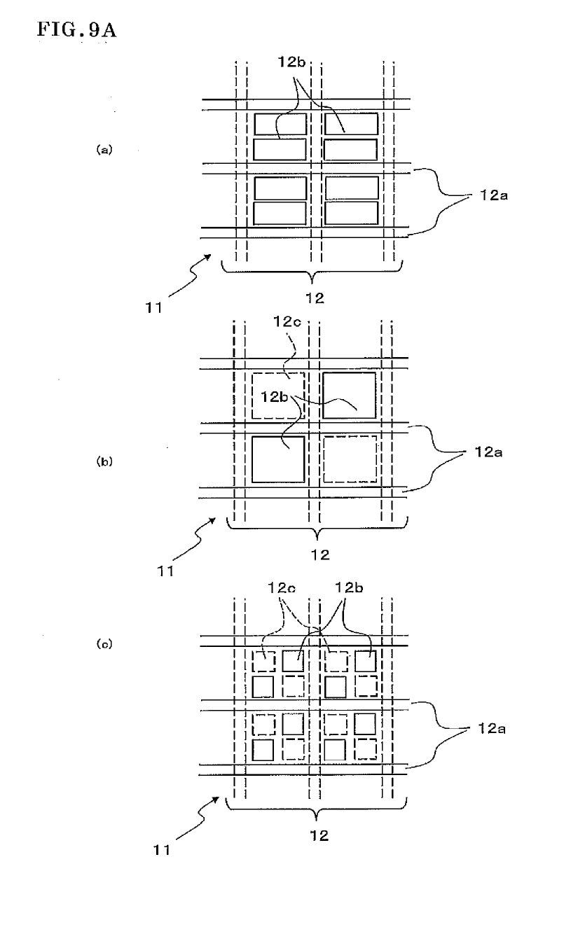

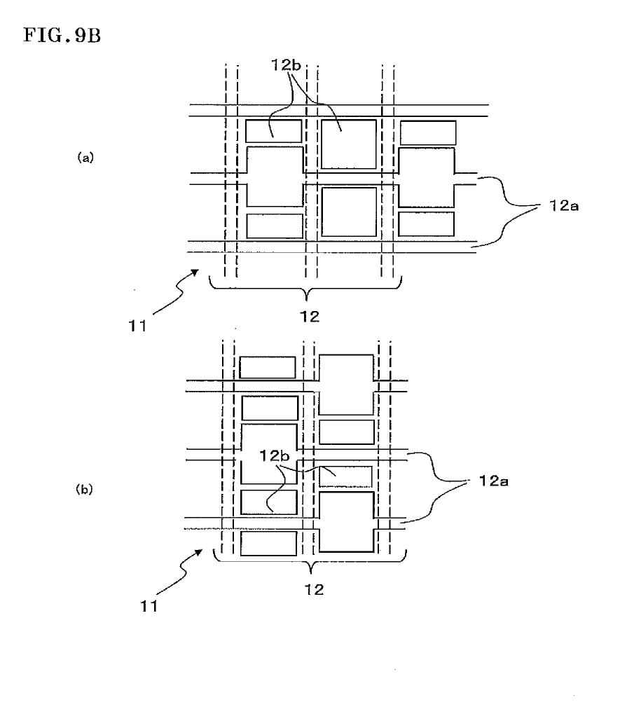

The width of a single pattered part 12a is preferably constant or changed periodically (see FIG. 9B(a)) although it does not have to be constant. When the patterned parts 12a have a constant width, the width is preferably from 1 to 10 mm, more preferably from 2 to 5 mm in view of the accuracy of input detection. When the patterned parts 12a vary in width, the width is preferably close to the pitch because of the sensitivity of detection. If the width is too close to the pitch, however, a short circuit may occur between the adjacent patterned parts depending on processing accuracy. Therefore, the width of the widest portion of the patterned part 12a is preferably 70 to 98%, more preferably 80 to 95% of the pitch between the patterned parts 12a.

In the invention, the pitch between the patterned parts 12a, the line width of the patterned parts 12a, and the material of the patterned parts 12a can be standardized. When the line width is standardized (e.g., 1 mm), the wiring resistance per unit length of the patterned parts 12a formed using ITO or the like can also be standardized. When the touch panel member is manufactured using a set of material rolls having such patterned parts 12a, the specifications of ICs for control circuits can also be standardized as described below.

The individual patterned parts 12a do not have to be linear and may extend parallel to one another, for example, in a wavy or zigzag form. In the invention, therefore, the individual patterned parts 12a only have to be arranged, without being in contact with one another, in such a manner that the center lines of the wavy or other forms extend parallel to one another.

As shown in FIG. 8C(b), a set of material rolls according to the invention is such that the transparent conductive layer 12 in at least one material roll 15A has dummy patterned parts 12b which are each placed between each set of the patterned parts 12a and arranged regularly along the extending direction of the patterned parts 12a depending on the pitch between the patterned parts 12a of the transparent conductive layer 12 in the other material roll 15B. As used herein, the term “arranged regularly depending on the pitch” means that the dummy patterned parts 12b or 12c are arranged in a period of about an integral multiple (such as 1-fold, 2-fold, or 3-fold) or about an integral fraction (such as ½ or ⅓) of the pitch.

FIG. 8C(b) shows an example in which only one (front-side one) of the transparent layers 12 of the long strips 16A and 16B has dummy patterned parts 12b on the front side. According to the invention, the structures shown in FIGS. 9A(a) to 9A(c) and FIGS. 9B(a) to 9B(b) may also be provided.

FIG. 9A(a) shows an example in which only one (front-side one) of the two transparent conductive layers 12 has dummy patterned parts 12b on the front side, in which two dummy patters 12b are provided in each cell of the lattice formed by the patterned parts 12a of the two layers. FIG. 9A(b) shows an example in which one of the two transparent layers 12 has dummy patterned parts 12b on the front side, and the other has dummy patterned parts 12c on the back side. FIG. 9A(c) shows an example in which the patterned parts 12a of the two layers form a lattice, and a plurality of dummy patterned parts 12b on the front side and a plurality of dummy patterned parts 12c on the back side are provided in a cell of the lattice.

The examples show that all the dummy patterned parts 12b and 12c are provided in cells of the lattice formed by the patterned parts 12a in the two layers. Alternatively, dummy patterned parts 12b or 12c may be provided so as to cross the patterned parts 12a on the back side. In this case, dummy patterned parts 12b or 12c can be provided having a regularity of about an integral multiple of the pitch.

Alternatively, as shown in FIG. 9B(a), the patterned parts 12a of one (front-side one) of the two transparent conductive layers 12 may alternately vary in width periodically, and two types of dummy patterned parts 12b, specifically , small and large dummy patterned parts 12b may be provided between the patterned part 12a with a constant width and the patterned part 12a that varies in width. As shown in FIG. 9B(b), the patterned parts 12a of one (front-side one) of the two transparent conductive layers 12 may each vary in width periodically, and different regularities may be used so that the wide portions can be arranged in a zigzag pattern. Rectangular dummy patterned parts 12b may also be provided adjacent to the wide portions.

FIG. 8D shows an example in which a touch panel member is manufactured using a set of material rolls 15A and 15B each including a transparent film substrate 11 and a transparent conductive layer 12 formed on one side of the transparent film substrate 11, in which the patterned parts 12a of the transparent conductive layers 12 each have a plurality of wide portions 12d or 12e whose width is made larger.

As shown in FIGS. 8D(a) to 8D(c), this example uses a combination of material rolls 15A and 15B, which include a roll of a long strip 16A and a roll of a long strip 16B, respectively. The long strips 16A and 16B each includes a transparent film substrate 11 and a transparent conductive layer 12 that is formed on one side of the transparent film substrate 11 and has patterned parts 12a arranged with a constant pitch and extending parallel to one another. The embodiment provides an example where the transparent conductive layer 12 having patterned parts 12a is formed directly on one side of the transparent film substrate 11.

In the illustrated example, the patterned parts 12a of the transparent conductive layer 12 in one material roll 15A extend parallel to the longitudinal direction of the long strip 16A, and the patterned parts 12a of the transparent conductive layer 12 in the other material roll 15B extend parallel to the widthwise direction of the long strip 16B. The patterned parts 12a extending in parallel may be inclined to the longitudinal direction of the long strips 16A and 16B. In view of the process of manufacturing the long strips 16A and 16B, however, the patterned parts 12a preferably extend in a direction parallel to the longitudinal or widthwise direction of the long strips 16A and 16B. In the invention, therefore, the patterned parts 12a of the transparent conductive layers 12 in both material rolls 15A and 15B may also extend parallel to the widthwise and longitudinal directions of the long strips 16A and 16B, respectively.

The pitch between the patterned parts 12a (or the distance between the center lines of the patterned parts 12a) of the transparent conductive layer 12 is preferably from 1 to 10 mm, more preferably from 2 to 6 mm because the finger size is usually fixed for capacitive touch panels.

In the invention, the patterned parts 12a may each vary in line width and may each have a plurality of wide portions 12d, which are formed periodically. In this case, the width of the narrowest portion is preferably from 1 to 10 mm, more preferably from 2 to 5 mm, in view of the accuracy of input detection and the reliability of patterning. The width of the widest portion (the maximum width of the wide portions 12d) is preferably close to the pitch because of the sensitivity of detection. If the width is too close to the pitch, however, a short circuit may occur between the adjacent patterned parts depending on processing accuracy. Therefore, the width of the widest portion is preferably 70 to 98%, more preferably 80 to 95% of the pitch between the patterned parts 12a.

In the invention, the pitch between the patterned parts 12a, the line width of the patterned parts 12a, and the material of the patterned parts 12a can be standardized. When they are standardized, the wiring resistance per unit length of the patterned parts 12a formed using ITO or the like can also be standardized. When the touch panel member is manufactured using a set of material rolls having such patterned parts 12a, the specifications of ICs for control circuits can also be standardized as described below.

The center lines of the patterned parts 12a should extend parallel to one another. Preferably, the center lines are straight lines.

As shown in FIG. 8D(b), a set of material rolls according to the invention may be such that the patterned parts 12a of the transparent conductive layer 12 in one material roll 15A each have a plurality of wide portions 12d whose width is made larger depending on the pitch between the patterned parts 12a of the transparent conductive layer 12 in the other material roll 15B, and the patterned parts 12a of the transparent conductive layer 12 in the latter material roll 15B each have a plurality of wide portions 12e whose width is made larger depending on the pitch between the patterned parts 12a of the transparent conductive layer 12 in the former material roll 15A. As used herein, the term “whose width is made larger depending on the pitch” means that the wide portions 12d are formed in a period substantially equal to the pitch.

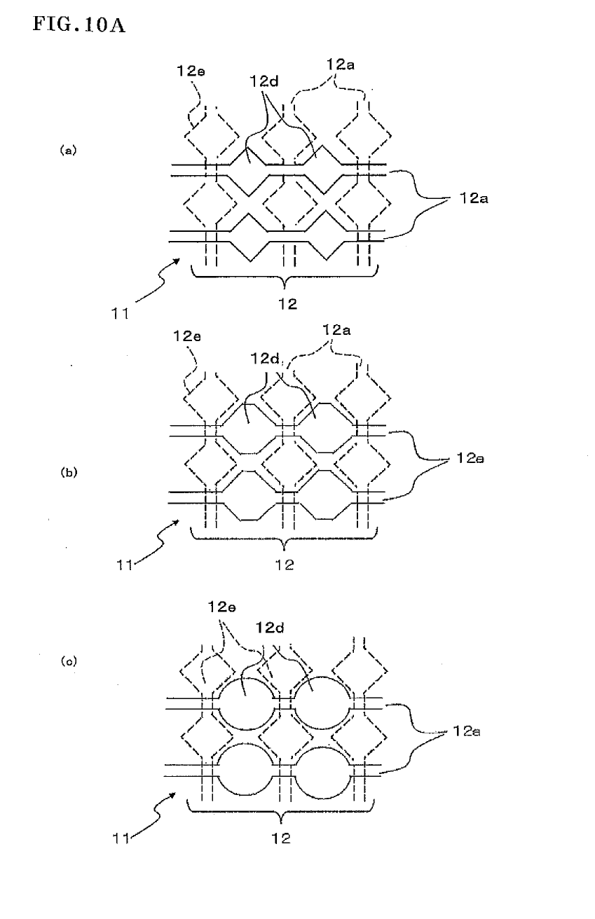

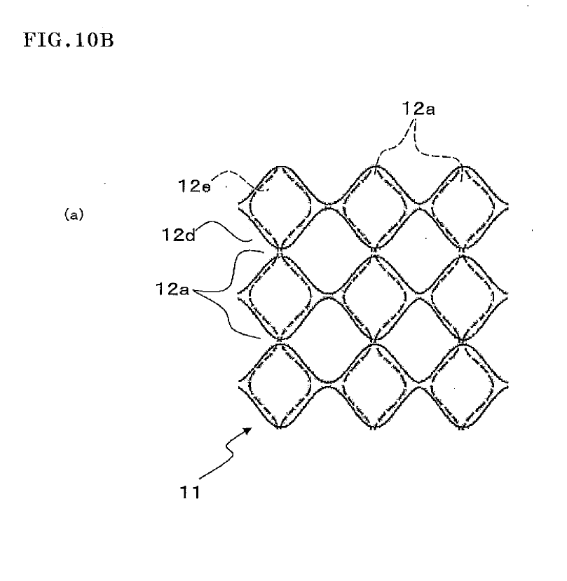

FIG. 8D(b) shows an example in which the patterned parts 12a of the transparent conductive layer 12 in at least one material roll 15A are each configured to have a plurality of square portions that have the same size, form the wide portions 12d, respectively, and are joined to one another at their opposite corners. In this example, the patterned parts 12a of the transparent conductive layers 12 in both of the material rolls 15A and 15B each have a plurality of square portions that each form the wide portion 12d or 12c and are joined at their opposite corners, and the square portions in the material rolls 15A and 15B have substantially the same size. Alternatively, the invention may also provide the structures shown in FIGS. 10A(a) to 10A(c) and FIG. 10B(a).

FIG. 10A(a) shows an example in which the patterned parts 12a of each of the two transparent conductive layers 12 each include a plurality of square portions that form wide portions 12d on the front side or wide portions 12e on the back side, respectively, have the same size, and are joined at their opposite corners with patterned portions with a constant width. When patterned portions with a constant width are used as joints, their line width is preferably from 1 to 10 mm, more preferably from 2 to 5 mm in view of the accuracy of input detection and the reliability of patterning.

FIG. 10A(b) shows an example in which the patterned parts 12a of one of the two transparent conductive layers 12 each include a plurality of polygonal (hexagonal) portions that form wide portions 12d on the front side, respectively, have the same size, and are joined at their opposite corners with patterned portions with a constant width.

FIG. 10A(c) shows an example in which the patterned parts 12a of one of the two transparent conductive layers 12 each include a plurality of circular (or oval) portions that form wide portions 12d on the front side, respectively, have the same size, and are joined at their opposite ends with patterned portions with a constant width.

Alternatively, as shown in FIG. 10B(a), the patterned parts 12a of the transparent conductive layer 12 in at least one material roll 15A may each have wide portions 12d that are repeatedly formed between a pair of sine wave-like curves. In the illustrated examples, the transparent conductive layers 12 in both material rolls 15A and 12B have the wide portions 12d and 12c, respectively.

The pair of sine wave-like curves are preferably shifted in phase by substantially half a wavelength so that the wide portions 12d can be formed between the curves. The two curves preferably have the same amplitude. In other words, the pair of sine wave-like curves are preferably line-symmetric with respect to the center line.

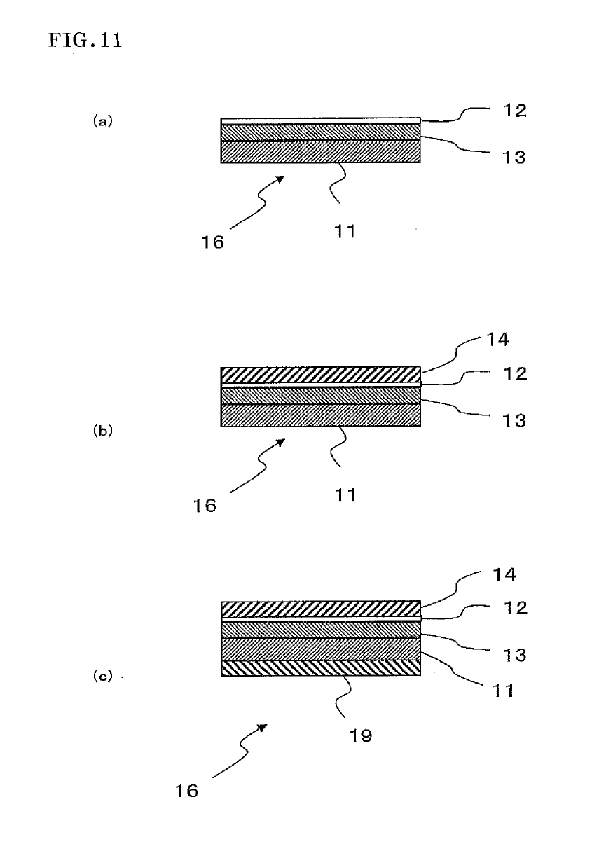

A description has been given of examples where the transparent conductive layers 12 of the long trips 16, 16A, and 16B are each formed directly on the transparent film substrate 11. Alternatively, as shown in FIGS. 11(a) to 11(c), in the invention, any other layer may also be provided between the transparent conductive layer 12 and the transparent film substrate 11 in the long strip 16 or the like, or any other layer may be provided on the surface of the transparent conductive layer 12 or the transparent film substrate 11.

FIG. 11(a) shows an example in which a dielectric layer 13 is provided between the transparent conductive layer 12 and the transparent film substrate 11 in the long strip 16. The dielectric layer 13 may be provided to reduce a difference in visibility between the regions of the transparent conductive layer 12 with and without the patterned part 12a. The dielectric layer 13 may have a multilayer structure. Any other layer such as a hard coating layer, a dielectric constant controlling layer, or an anti-reflection (reflection reducing) layer may also be provided between the transparent conductive layer 12 and the transparent film substrate 11.

FIG. 11(b) shows an example in which a hard coating layer 14 is further provided on the surface of the transparent conductive layer 12 of the long strip 16. The hard coating layer 14 may also be provided with a transparent base material interposed between the layers. The transparent base material may be placed on the layer with a transparent pressure-sensitive adhesive layer or the like.

FIG. 11(c) shows an example in which a transparent pressure-sensitive adhesive layer 19 is further provided on the surface of the transparent film substrate 11 of the long strip 16. The pressure-sensitive adhesive layer 19 may be used when two long strips 16A and 16B are stacked, two electrode members 10 are stacked, or any other member such as a transparent base material or a liquid crystal cell is placed thereon. If necessary, a separator may be placed on the pressure-sensitive adhesive layer 19.

Next, materials for the rolls will be described. The long strips 16, 16A, and 16B used to form the material rolls 15, 15A, and 15B each consist essentially of the transparent conductive layer 12 and the transparent film substrate 11, and if necessary, may have an optional component such as the dielectric layer 13, the hard coating layer 14, the pressure-sensitive adhesive layer 19, or the transparent base material.

The material, refractive index, and thickness of the transparent film substrate 11, the material and thickness of the dielectric layer 13 and the method for forming the dielectric layer 13, the material, refractive index, and thickness of the transparent conductive layer 12 and the method for forming the transparent conductive layer 12, the pressure-sensitive adhesive used to form the pressure-sensitive adhesive layer 19, the separator, the hard coating layer (resin layer) 14, and other components are as described in the section “Materials for touch panel member.”

The long strips 16A and 16B may be produced by any method capable of forming the dielectric layer 13 and the transparent conductive layer 12 on one side of the transparent film substrate 11 as described above. According to a conventional method, for example, the long strip 16A or 16B can be produced by a process that includes forming the dielectric layer 13 on one side of the transparent film substrate 11, forming a transparent conductive layer 12-containing transparent conductive film on one side of the transparent film substrate 11 with the dielectric layer 13 interposed therebetween, and optionally patterning the transparent conductive layer 12 by etching. The etching process preferably includes covering the pattern parts 12a with a patterning mask and etching the transparent conductive layer 12 using an etching solution.

When two components such as two long strips 16A and 16B are laminated with the pressure-sensitive adhesive layer 19 interposed therebetween, the pressure-sensitive adhesive layer 19 may be of any type having transparency.

(Step of Forming Electrode Member)

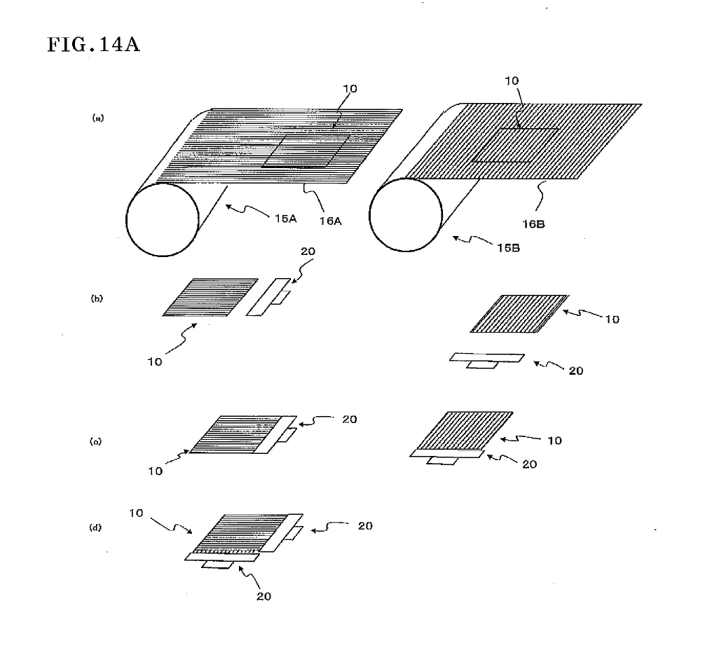

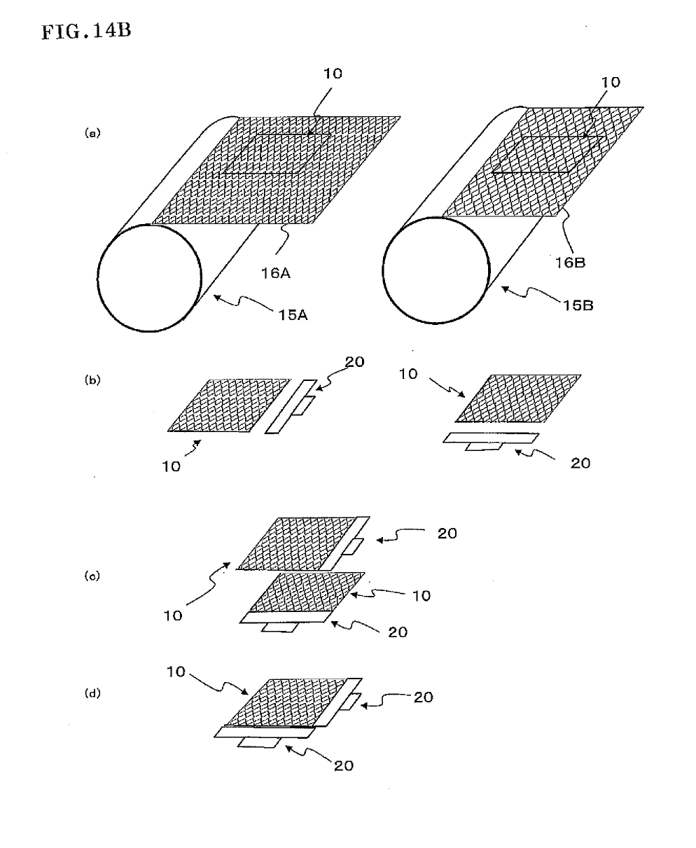

As shown in FIGS. 14A to 14B, a method of the invention for manufacturing a touch panel member includes the step of unrolling the long strip 16 from the material roll 15 and then cutting the long strip 16 to form an electrode member 10 including a transparent film substrate 11 and a transparent conductive layer 12 formed on at least one principal surface of the transparent film substrate 11, wherein the transparent conductive layer 12 has patterned parts 12a arranged with a constant pitch and extending parallel to one another.

In the electrode member 10, the transparent conductive layer 12 has patterned parts 12a that are arranged with a constant pitch and extend parallel to one another, and the transparent conductive layer 12 is formed on at least one principal surface of the transparent film substrate 11. As used herein, the phrase “the transparent conductive layer 12 is formed on the principal surface” means that the patterned parts 12a are formed over substantially the entire surface of the transparent film substrate 11 (80% or more, preferably 90% or more, more preferably 95% or more of the entire surface area).

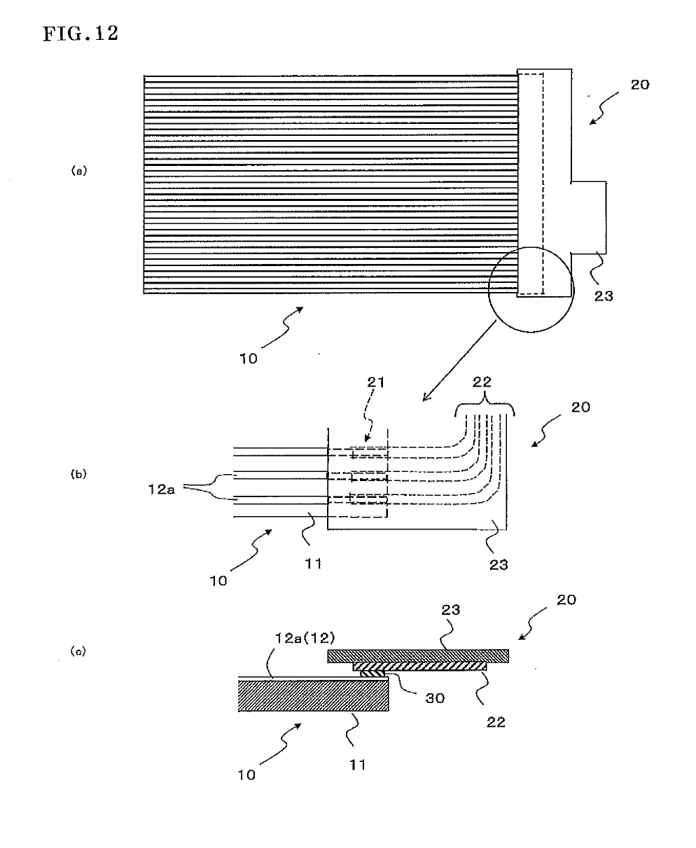

FIG. 12 shows an example in which the transparent conductive layer 12 is formed on one principal surface of the transparent film substrate 11, and the transparent conductive layer 12 has patterned parts 12a that extend in a direction parallel to the long side of the electrode member 10 and each have a constant width. The electrode member 10 usually has a rectangular or square external shape, but may have any other external shape. Alternatively, the patterned parts 12a extending in parallel may be in a direction oblique to the long side. In view of operation area, however, the patterned parts 12a preferably extend in a direction parallel to the long or short side of the electrode member 10.

The transparent film substrate 11 may have any suitable size, which corresponds to the size of an input unit, depending on the size of a display. In the case of a capacitive touch panel, the size of the transparent film substrate 11 is more preferably set suitable for a mobile device in view of the sheet resistance of the transparent conductive film. For example, the size may be 3 to 5 inches for cellular phones or smart phones, 6 to 10 inches for tablet PCs, or 10 to 20 inches for notebook PCs or monitors. In the technique according to the invention, however, relatively small device sizes are preferred in view of connection to the wiring member although such sizes are non-limiting. In the invention where the transparent conductive layer can be standardized, the pitch between the patterned parts 12a, the width of the patterned parts 12a, and the surface resistance of the patterned parts 12a are preferably each set at several different levels depending on the size of parts corresponding to input units.

FIG. 13A shows an example in which the transparent conductive layers 12 are formed on both principal surfaces of the transparent film substrate 11, one of the transparent conductive layers 12 has patterned parts 12a extending in a direction parallel to the long side of the electrode member 10, and the other transparent conductive layer 12 has patterned parts 12a extending in a direction parallel to the short side of the electrode member 10. This electrode member 10 can be produced simply by cutting the long strip 16 into a predetermined size, in which the long strip 16 include the transparent film substrate 11 and the transparent conductive layers 12 formed on both sides of the transparent film substrate 11.

FIG. 13B shows an example in which the transparent conductive layer 12 of one of the electrode members 10 has patterned parts 12a that extend in a direction parallel to the long side of the electrode member 10 and each have a constant width, and the transparent conductive layer 12 of the other electrode member 10 has patterned parts 12a that extend in a direction parallel to the short side of the electrode member 10 and each have a constant width. These electrode members 10 can be produced simply by cutting the long strips 16A and 16B into predetermined sizes. The electrode members 10 usually have a rectangular or square external shape, but may have any other external shape. The patterned parts 12a parallel to one another preferably extend in a direction parallel to the long or short side of the electrode member 10.

FIG. 13C shows an example in which the transparent conductive layer 12 of one of the electrode members 10 has patterned parts 12a that extend in a direction parallel to the long side of the electrode member 10 and each have wide portions 12d, and the transparent conductive layer 12 of the other electrode member 10 has patterned parts 12a that extend in a direction parallel to the short side of the electrode member 10 and each have wide portions 12e. These electrode members 10 can be produced simply by cutting the long strips 16A and 16B into predetermined sizes.

The cutting of the long strip 16 may be performed by a method of punching a piece of a predetermined size out of the strip 16 using a Thomson blade or the like. Alternatively, the cutting may be performed by a method that includes using the material roll 15 having a width corresponding to the long or short side of the predetermined size and cutting the material into a piece with a length corresponding to the long or short side, in which a cutting blade such as a circular knife, a rotary knife, a knife, or a force-cutting blade, or a laser may be used for the cutting.

In the invention, patterning is not performed for one specific type of touch panel product, but the patterned parts 12a are formed in a certain standard pattern such as a certain standard stripe pattern. In the invention, the material is cut into the electrode members 10 of a predetermined size or sizes, so that touch panel members for touch panel products of various shapes and sizes can be obtained from a material roll having the patterned parts 12a arranged with one or several pitches.

Therefore, the area in which the standard pattern for the electrode member 10 is formed only has to be sufficiently larger than the size of the touch panel member to be formed. For patterning convenience, for example, the area may be formed in each of about 1-m-long separate sections. For example, when the size of the touch panel product is at most about 200 mm×150 mm, the patterns may be formed with a pitch of 1 m in the longitudinal direction, respectively, in the areas with a width of 800 mm. One of the areas can be divided into up to 5 or 6 pieces in the longitudinal direction and 5 or 4 pieces in the widthwise direction, so that 24 or 25 pieces of film can be obtained from one of the areas.

In the invention, the electrode members 10 can be formed by punching pieces, which are shaped depending on the touch panel, out of the long strip in which such a standardized pattern is continuously formed. Therefore, the touch panel members can be obtained from sections that are continuous or almost adjacent to one another, so that they can be produced with almost no loss of film.

(Step of Preparing Wiring Member)

As shown in FIGS. 14A to 14B, the method of the invention for manufacturing a touch panel member includes the step of preparing a flexible wiring member 20 including first connecting parts 21 and conductive patterned parts 22 extending from the first connecting parts 21, respectively, wherein the first connecting parts 21 are arranged with a pitch corresponding to the pitch between the patterned parts 12a.

As shown in FIGS. 12 and 13A to 13C, the flexible wiring member 20 includes first connecting parts 21 and conductive patterned parts 22, in which the first connecting parts 21 are arranged with a pitch corresponding to the pitch between the patterned parts 12a, and the conductive patterned parts 22 are formed to extend from the first connecting parts 21, respectively. The flexible wiring member 20 maybe structured similarly to a flexible printed circuit (FPC) board. For example, the flexible wiring member 20 includes a flexible insulating substrate 23 and the conductive patterned parts 22 or the like formed on the flexible insulating substrate 23. In the illustrated example, there is a portion in which the pitch between the conductive patterned parts 22 is made narrower than that between the first connecting parts 21 so that the wiring density is increased.

The wiring member 20 is stacked and disposed on the electrode member 10 so as to be electrically connected to the electrode member 10. The wiring member 20 is stacked and disposed on the electrode member 10 in such a manner that the first connecting parts 21 of the wiring member 20 faces the patterned parts 12a of the electrode member 10, respectively. The wiring member 20 and the electrode member 10 overlap each other preferably over a relatively long distance for good connection between the patterned parts 12a and the first connecting parts 21. In order to narrow the frame, however, the connected part is preferably as short as possible, as long as it can ensure reliability. In general, the overlap distance is preferably, but not limited to, 0.5 to 10 mm, more preferably 1 to 5 mm.

The line width of the first connecting parts 21 is preferably substantially the same as that of the patterned parts 12a or preferably 0.3 to 3 mm in order to provide a good electrical connection to the patterned parts 12a of the transparent conductive layer 12. In view of wiring resistance, the line width is preferably as large as possible.

The opposite ends of the conductive patterned parts 22 from the first connecting parts 21 may also be provided with external connecting parts for connection to an external wiring board. In the invention, therefore, the wiring member 20 can also serve as an FPC for connecting the touch panel to an external wiring board.

In the wiring member 20, the first connecting parts 21 are formed with a pitch that conforms to the standardized stripe pattern of the electrode member 10 so that the first connecting parts 21 can be arranged with a pitch corresponding to the pitch between the patterned parts 12a. Therefore, the wiring member 20 can also be manufactured in several different styles (standardization) depending on the number of the patterned parts 12a of the transparent conductive layer 12.

The flexible wiring member 20 consists essentially of the flexible insulating substrate 23 and the conductive patterned parts 22, and if necessary, may have an optional component such as an adhesive layer provided to bond the insulating substrate 23 and the conductive patterned parts 22, a cover insulating layer provided to shield the conductive patterned parts 22, or a solder resist layer. These components are as described above in the section “Materials for touch panel member.”

(Step of Forming Touch Panel Member)

As shown in FIGS. 14A to 14B, the method of the invention for manufacturing a touch panel member includes the step of electrically connecting the patterned parts 12a of the electrode member 10 to the first connecting parts 21 of the wiring member 20, respectively, to form a touch panel member.

As shown in FIGS. 12(a) to 12(c), for example, the resulting touch panel member includes the electrode member 10, which includes the transparent film substrate 11 and the transparent conductive layer 12 formed on one principal surface of the transparent film substrate 11; the flexible wiring member 20 having the conductive patterned parts 22; and a conductive connection part 30 adapted to electrically connect the electrode member 10 to the wiring member 20. In the example of FIGS. 12(a) to 12(c), the electrode member 10 including the transparent film substrate 11 and the transparent conductive layer 12 formed on one principal surface of the transparent film substrate 11 is paired with the wiring member 20 to form the touch panel member.

The conductive connection part 30 is provided to electrically connect the first connecting parts 21 to the patterned parts 12a of the electrode member 10. The conductive connection part 30 may be a solder connection formed using solder or the like, a connection formed using an anisotropic conductive material, a connection formed using a conductive paste, a physical connection, or a fusion bond formed using a low melting point metal. In the invention, the conductive connection part 30 is preferably formed using an anisotropic conductive material.

The anisotropic conductive material maybe a polymer film containing conductive particles uniformly dispersed in an adhesive, in which conduction occurs only in the direction of the thickness of the film. The electric connection using the anisotropic conductive material can be made by placing strip-shaped anisotropic conductive materials between the patterned parts 12a of the electrode member 10 and the first connecting parts 21 of the wiring member 20, respectively, and then subjecting them to thermocompression bonding.

The anisotropic conductive material generally has a thickness of about 25 to about 50 μm. The thermocompression bonding may include, for example, pressing under a pressure of 2 to 4 MPa and heating at a temperature of 170 to 220° C., depending on the type of the anisotropic conductive material.

As shown in FIG. 13A, the touch panel member may also be configured to include an electrode member 10 including the transparent film substrate 11 and the transparent conductive layers 12 formed on both sides of the transparent film substrate 11. The pattered parts 12a preferably cross each other at an angle of 45 degrees or more, more preferably 85 degrees or more, most preferably 90 degrees. In the illustrated example, the patterned parts 12a cross each other at an angle of 90 degrees.

As shown in FIG. 13B, the touch panel member may also be configured to include a laminate of two layers of the electrode member 10. This structure can be obtained by a process that includes integrally laminating the long strips 16A and 16B in advance and cutting the laminate into a predetermined size or by a process that includes cutting the long strips 16A and 16B and then integrally laminating the resulting pieces. Specifically, in the invention, two layers of the electrode member 10 may be stacked in such a manner that the patterned parts 12a are arranged to cross each other without being in contact with each other, and the wiring member 20 and the conductive connection part 30 may be provided for each of the two transparent conductive layers 12. In the illustrated example, the patterned parts 12a are placed on the upper side of each of the two layers of the electrode member 10. The two layers may be laminated with a transparent adhesive, a transparent pressure-sensitive adhesive, or a transparent adhesive film.

When the touch panel member shown in FIG. 13B is manufactured, the manufacturing process further includes the step of bonding the electrode members 10, which are obtained from the material rolls 15A and 15B, respectively, together in such a manner that the respective sets of patterned parts 12a are arranged to cross each other without being in contact with each other. The pattered parts 12a preferably cross each other at an angle of 45 degrees or more, more preferably 85 degrees or more, most preferably 90 degrees. In the illustrated example, the patterned parts 12a cross each other at an angle of 90 degrees.

The wiring members 20 are each disposed on the electrode member 10 so as to be electrically connected to the electrode member 10. In the illustrated example, the two wiring members 20 are arranged in such a manner that the first connecting parts 21 and the conductive patterned parts 22 are both placed on the lower side. The two layers of the electrode member 10 have different shapes, and each have an overlap portion that is placed outside the portion to be used for input and placed over the wiring member 20. The electrode member 10 placed on the lower side has an overlap portion extending toward the upper side of the drawing, and the overlap portion is exposed from the electrode member 10 placed on the upper side. On the other hand, the electrode member 10 on the upper side has an overlap portion extending toward the right side of the drawing, and is so configured that the overlap portion is not placed over the electrode member 10 on the lower side.

Two layers of the electrode member 10 may be stacked in such a manner that the patterned parts 12a of the upper electrode member 10 are placed on the upper side and the pattered parts 12a of the lower electrode member 10 are placed on the lower side.

Alternatively, the patterned parts 12a of the upper electrode member 10 may be placed on the lower side, and the patterned parts 12a of the lower electrode member 10 may be placed on the upper side. In this case, two layers of the electrode member 10 are preferably bonded with a transparent insulating film or other means interposed therebetween so that the patterned parts 12a can be prevented from being in contact with each other. When the electrode members 10 are stacked in such a manner that the patterned parts 12a of them are opposed to each other, the electrode member 10 placed on the lower side preferably has an overlap portion exposed from the electrode member 10 placed on the upper side, and the electrode member 10 on the upper side preferably has an overlap portion exposed from the electrode member 10 on the lower side.

As shown in FIG. 13C, another touch panel member can also be obtained, in which the patterned parts 12a of the transparent conductive layer 12 in one of the electrode members 10 each have a plurality of wide portions 12d whose width is made larger depending on the pitch between the patterned parts 12a of the transparent conductive layer 12 in the other electrode member 10, and the patterned parts 12a of the transparent conductive layer 12 in the latter electrode member 10 each have a plurality of wide portions 12d whose width is made larger depending on the pitch between the patterned parts 12a of the transparent conductive layer 12 in the former electrode member 10.

### DESCRIPTION OF REFERENCE SIGNS

In the drawings, reference sign 10 represents an electrode member, 11 a transparent film substrate, 12 a transparent conductive layer, 12a a patterned part, 12b a dummy patterned part (front side), 12c a dummy patterned part (back side), 12d a wide portion (front side), 12c a wide portion (back side), 14 a hard coating layer, 15, 15A, and 15B each a material roll, 16, 16A, and 16B each a long strip, 19 a pressure-sensitive adhesive layer, 20 a wiring member, 21 a first connecting part, 22 a conductive patterned part, 23 an insulating substrate, and 30 a conductive connection part.

1. A touch panel member, comprising:
an electrode member comprising a transparent film substrate and a transparent conductive layer that is formed on at least one principal surface of the transparent film substrate and has patterned parts arranged with a constant pitch and extending parallel to one another; and
a flexible wiring member comprising first connecting parts arranged with a pitch corresponding to the pitch between the patterned parts and conductive patterned parts extending from the first connecting parts, respectively.

2. The touch panel member according to claim 1, further comprising a conductive connection part adapted to electrically connecting the patterned parts of the electrode member to the first connecting parts.

3. The touch panel member according to claim 1, wherein the transparent conductive layer is provided on each of both sides of the transparent film substrate, the patterned parts of the two transparent conductive layers on both sides are arranged to cross each other, and the wiring member is provided for each of the two transparent conductive layers.

4. The touch panel member according to claim 1, wherein two layers of the electrode member are stacked in such a manner that the patterned parts of the two layers are arranged to cross each other without being in contact with each other, and the wiring member is provided for each of the two transparent conductive layers.

5. The touch panel member according to claim 3, wherein at least one of the two transparent conductive layers has dummy patterned parts that are each provided between the patterned parts and are arranged regularly depending on the pitch between the patterned parts of another of the transparent conductive layers.

6. The touch panel member according to claim 3, wherein the patterned parts of one of the two transparent conductive layers have a plurality of wide portions whose width is made larger depending on the pitch between the patterned parts of another of the two transparent conductive layers, and the patterned parts of said another of the two layers have a plurality of wide portions whose width is made larger depending on the pitch between the patterned parts of said one of the two layers.

7. The touch panel member according to claim 6, wherein the wide portions of the patterned parts of the two transparent conductive layers are diamond-shaped.

8. A touch panel comprising the touch panel member according to claim 1.

9. A method for manufacturing a touch panel member, comprising the steps of:
preparing a material roll comprising a roll of a long strip comprising a transparent film substrate and a transparent conductive layer formed on at least one side of the transparent film substrate, wherein the transparent conductive layer has patterned parts arranged with a constant pitch and extending parallel to one another;
unrolling the long strip from the material roll and thereafter cutting the long strip to form an electrode member comprising a transparent film substrate and a transparent conductive layer formed on at least one principal surface of the transparent film substrate, wherein the transparent conductive layer has patterned parts arranged with a constant pitch and extending parallel to one another;
preparing a flexible wiring member comprising first connecting parts arranged with a pitch corresponding to the pitch between the patterned parts and conductive patterned parts extending from the first connecting parts, respectively; and
electrically connecting the patterned parts of the electrode member to the first connecting parts of the wiring member, respectively, to form a touch panel member.

10. The method for manufacturing the touch panel member according to claim 9, wherein the patterned parts of the material roll extend parallel to the longitudinal or widthwise direction of the long strip.

11. The method for manufacturing the touch panel member according to claim 9, wherein the material roll prepared is a roll of a long strip having the transparent conductive layer formed on each of both sides of the transparent film substrate, wherein the patterned parts of the transparent conductive layers are arranged to cross each other, and the first connecting parts of the wiring member prepared for each of the transparent conductive layers are electrically connected to the patterned parts of the transparent conductive layer, respectively.

12. The method for manufacturing the touch panel member according to claim 9, comprising the steps of preparing two material rolls as said material roll, each comprising a roll of a long strip comprising a transparent film substrate and a transparent conductive layer formed on one side of the transparent film substrate and having patterned parts arranged with a constant pitch and extending parallel to one another, obtaining the electrode member from each of the two material rolls, and laminating the electrode members in such a manner the patterned parts of the electrode members are arranged to cross each other without being in contact with each other, wherein the first connecting parts of the wiring member prepared for each of the transparent conductive layers are electrically connected to the patterned parts of the transparent conductive layer, respectively.

13. A set of material rolls, comprising a set of rolls of long strips each comprising a transparent film substrate and a transparent conductive layer that is formed on one side of the transparent film substrate and has patterned parts arranged with a constant pitch and extending parallel to one another, wherein the transparent conductive layer in at least one of the material rolls has dummy patterned parts that are each provided between each set of the patterned parts and are arranged regularly along the extending direction of the patterned parts depending on the pitch between the patterned parts of the transparent conductive layer in another of the material rolls.

14. The set of material rolls according to claim 13, wherein the dummy patterned parts are each formed to have the same shape and regularity.

15. The set of material rolls according to claim 13, wherein the patterned parts of the transparent conductive layer in at least one of the material rolls are linearly formed with a constant line width.

16. A set of material rolls, comprising a set of rolls of long strips each comprising a transparent film substrate and a transparent conductive layer that is formed on one side of the transparent film substrate and has patterned parts arranged with a constant pitch and extending parallel to one another, wherein the patterned parts of the transparent conductive layer in one of the material rolls have a plurality of wide portions whose width is made larger depending on the pitch between the patterned parts of the transparent conductive layer in another of the material rolls, and the patterned parts of the transparent conductive layer in said another of the material rolls have a plurality of wide portions whose width is made larger depending on the pitch between the patterned parts of the transparent conductive layer in said one of the material rolls.

17. The set of material rolls according to claim 16, wherein the patterned parts of the transparent conductive layer in at least one of the material rolls are each shaped to have a plurality of square portions that have the same size, form the wide portions, respectively, and are joined to one another at their opposite corners.

18. The set of material rolls according to claim 17, wherein the patterned parts of the transparent conductive layer in each of both material rolls are each shaped to have a plurality of square portions that form the wide portions, respectively, and are joined to one another at their opposite corners, and the square portions in both material rolls have substantially the same size.
